(19) United States
(12) Patent Application Publication
(10) Pub. No.: US 2026/0235978 A1
(43) Pub. Date: Aug. 13, 2026

(54) IMAGE FORMING APPARATUS

(71) Applicant: CANON KABUSHIKI KAISHA, Tokyo (JP)

(72) Inventor: TAKUYA HAYATO, Kanagawa (JP)

(21) Appl. No.: 19/539,850

(22) Filed: Feb. 13, 2026

(30) Foreign Application Priority Data
Feb. 13, 2025 (JP) 2025-021892
Dec. 9, 2025 (JP) 2025-243781

(51) Int. Cl. G03G 15/08

(52) U.S. Cl. CPC G03G 15/0875; G03G 15/0868

(57) ABSTRACT

An image forming apparatus includes a first toner cartridge, a second toner cartridge, a photosensitive drum, a rotary movable to a first exchange position and a second exchange position, a main assembly, a reading portion, a driving portion, and a controller. In a case where the first toner cartridge is mounted to the rotary in a state in which mounting of the second toner cartridge to the rotary is permitted, the controller performs (i) a first reading operation for reading first information, and (ii) an exchange preparation operation for positioning the rotary in the second exchange position after the first reading operation and before a first additional reading operation for reading second information.

### BACKGROUND

### Field of the Technology

The present disclosure relates to an image forming apparatus using a rotary development type, and particularly relates to exchange control of a toner cartridge.

### Description of the Related Art

In an image forming apparatus of an electrophotographic type, the rotary development type in which a color image is formed by rotating a rotary provided with a plurality of developing rollers is known. In Japanese Laid-Open Patent Application (JP-A) Nos. 2007-183305 and 2008-096852, an image forming apparatus including a rotary in which a plurality of developing devices provided with developing rollers are accommodated and a plurality of toner cartridges detachably mountable to the plurality of developing devices, respectively, is disclosed. In such an image forming apparatus, in the case where a plurality of toner cartridges are exchanged, a rotary is rotated after one toner cartridge is exchanged, and then another toner cartridge is exchanged.

Further, in JP-A No. 2018-205697, it is disclosed that a storing device in which an image forming condition optimized for each of toner cartridges is stored is provided. The image forming apparatus reads the image forming condition from the storing device during toner cartridge exchange and is capable of carrying out image formation control on the basis of the read image forming condition.

In the case where the plurality of toner cartridges are exchanged by a user, when a time from after one toner cartridge is exchanged until exchange of another toner cartridge is permitted is long, a waiting time of the user increases.

### SUMMARY

The present disclosure has been accomplished in view of the above-described circumstances and is directed to shorten the time from after one toner cartridge is exchanged until exchange of another toner cartridge is permitted in the case where the plurality of toner cartridges are exchanged.

In order to solve the above-described problem, according to an aspect of the present disclosure, there is provided an image forming apparatus to which a first toner cartridge including a first storing portion and a second toner cartridge are detachably mountable, wherein the image forming apparatus is configured to execute an image forming operation for forming an image on a recording material, the image forming apparatus comprising: a photosensitive drum; a rotary to which the first toner cartridge and the second toner cartridge are detachably mountable, the rotary including (i) a first developing device accommodating toner supplied from the first toner cartridge and including a first developing roller, and (ii) a second developing device accommodating toner supplied from the second toner cartridge and including a second developing roller, wherein the rotary is rotatable so that each of the first developing roller and the second developing roller opposes the photosensitive drum; a main assembly including the rotary and provided with an opening; a reading portion; a driving portion configured to rotate the rotary so that the rotary takes a first exchange position and a second exchange position, wherein mounting of the first toner cartridge to the first developing device through the opening is permitted when the rotary is in the first exchange position, and mounting of the second toner cartridge to the second developing device through the opening is permitted when the rotary is in the second exchange position; and a controller configured to control the driving portion, wherein in a case where the first toner cartridge is mounted to the rotary, the controller reads first information and second information from the first storing portion through the reading portion before the image forming operation is executed, and wherein in a case where the first toner cartridge is mounted to the rotary in a state in which mounting of the second toner cartridge to the rotary is permitted, the controller performs (i) a first reading operation for reading the first information, and (ii) an exchange preparation operation for positioning the rotary in the second exchange position after the first reading operation and before a first additional reading operation for reading the second information.

According to another aspect of the present disclosure, there is provided an image forming apparatus to which a first toner cartridge including a first storing portion and a second toner cartridge including a second storing portion are detachably mountable, wherein the image forming apparatus is configured to execute an image forming operation for forming an image on a recording material, the image forming apparatus comprising: a photosensitive drum; a rotary to which the first toner cartridge and the second toner cartridge are detachably mountable, the rotary including (i) a first developing device accommodating toner supplied from the first toner cartridge and including a first developing roller, and (ii) a second developing device accommodating toner supplied from the second toner cartridge and including a second developing roller, wherein the rotary is rotatable so that each of the first developing roller and the second developing roller opposes the photosensitive drum; a main assembly including the rotary and provided with an opening; a reading portion; a driving portion configured to rotate the rotary so that the rotary takes a first exchange position, a second exchange position, a first reading position, and a second reading position, wherein mounting of the first toner cartridge to the first developing device through the opening is permitted when the rotary is in the first exchange position, mounting of the second toner cartridge to the second developing device through the opening is permitted when the rotary is in the second exchange position, reading of information, stored in the first storing portion, by the reading portion is permitted when the rotary is in the first reading position, and reading of information, stored in the second storing portion, by the reading portion is permitted when the rotary is in the second reading position; and a controller configured to control the driving portion, wherein in a case where the first toner cartridge is mounted to the rotary in a state in which mounting of the second toner cartridge to the rotary is permitted, the controller performs a first reading preparation operation for positioning the rotary in the first reading position and an exchange preparation operation for positioning the rotary in the second exchange position after the first reading preparation operation, and performs, after the exchange preparation operation and before the image forming operation, a second reading preparation operation for positioning the rotary in the second reading position and the first reading preparation operation.

Features of the present disclosure will become apparent from the following description of embodiments with reference to the attached drawings. The following description of embodiments are described by way of example.

### BRIEF DESCRIPTION OF THE DRAWINGS

FIG. 1 is a sectional view showing an image forming apparatus of embodiments 1 and 2.

FIG. 2 is a sectional view of a toner cartridge and a developing unit in the embodiments 1 and 2.

Parts (a) and (b) of FIG. 3 are sectional views each of a rotary and a periphery thereof in the embodiments 1 and 2.

FIG. 4 is a schematic view of an outer appearance of the rotary in the embodiments 1 and 2.

Parts (a), (b), and (c) of FIG. 5 are schematic views each of an outer appearance of an image forming apparatus main assembly in the embodiments 1 and 2.

FIG. 6 is a sectional view of the rotary and the periphery thereof during exchange of the toner cartridge in the embodiments 1 and 2.

FIG. 7 is a perspective view showing a tray arrangement in the rotary in the embodiments 1 and 2.

FIG. 8 is a sectional view showing the tray arrangement in the rotary in the embodiments 1 and 2.

Parts (a) and (b) of FIG. 9 are perspective views showing a drive configuration of insertion/extraction of a tray in the embodiments 1 and 2.

Parts (a) and (b) of FIG. 10 are sectional views showing the drive configuration of the insertion/extraction of the tray in the embodiments 1 and 2.

Parts (a) and (b) of FIG. 11 are a perspective view and a schematic view, respectively, showing a configuration of a cartridge memory and a memory reading portion in the embodiments 1 and 2.

FIG. 12 is a schematic view showing a memory map of the cartridge memory in the embodiments 1 and 2.

FIG. 13 is a schematic view showing an arrangement of the memory reading portion in the embodiments 1 and 2.

FIG. 14 is a block diagram of the image forming apparatus in the embodiment 1.

FIG. 15 is a timing chart showing toner cartridge exchange (one) in the embodiment 1.

FIG. 16 is a timing chart showing toner cartridge exchange (plurality) in the embodiment 1.

FIG. 17 is a flowchart showing toner cartridge exchange processing in the embodiment 1.

FIG. 18 is a block diagram of the image forming apparatus in the embodiment 2.

FIG. 19 is a timing chart showing toner cartridge exchange in the embodiment 2.

FIG. 20 is a flowcharts showing toner cartridge exchange processing in the embodiment 2.

### DESCRIPTION OF THE EMBODIMENTS

In the following, embodiments according to the present disclosure will be described while marking reference to the drawings.

### Embodiment 1

### General configuration of image forming apparatus

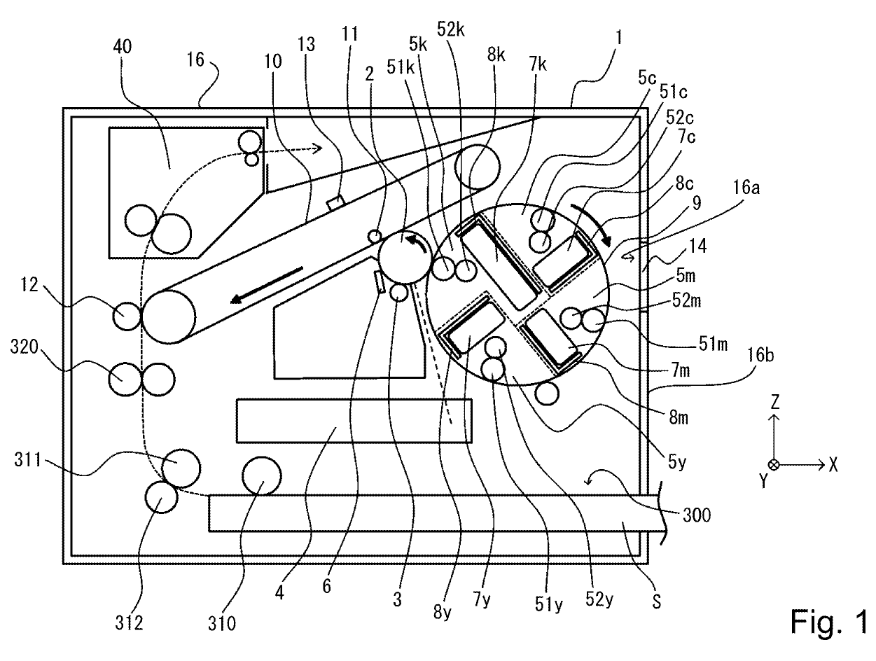

Using FIGS. 1 to 11, an embodiment of an image forming apparatus according to the present disclosure will be described.

In the following description and respective drawings, a vertical direction in the case where the printer main body 1 is installed on a horizontal surface is referred to as a Z direction. A direction which is a direction crossing the Z direction and which extends along a rotational axis of a rotary 9 described later (rotational axis direction of the rotary) is referred to as a Y direction. A direction crossing the Z direction and the Y direction is referred to as an X direction. The X direction and the Y direction may preferably be a horizontal direction. Further, the X direction, the Y direction, and the Z direction may preferably be perpendicular to each other. Further, as desired, directions of arrows X, Y and Z indicated in the respective drawings are represented by +X side, +Y side, and the +Z side, and sides opposite to these directions are represented by -X side, -Y side, and -Z side, respectively. In this embodiment, as an image forming apparatus provided with a plurality of developing units, a color laser beam printer provided with four developing units is illustrated as an example.

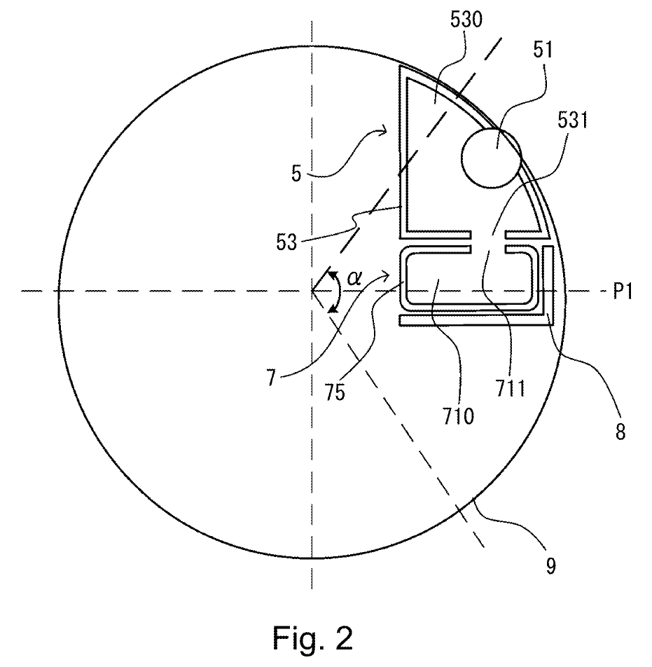

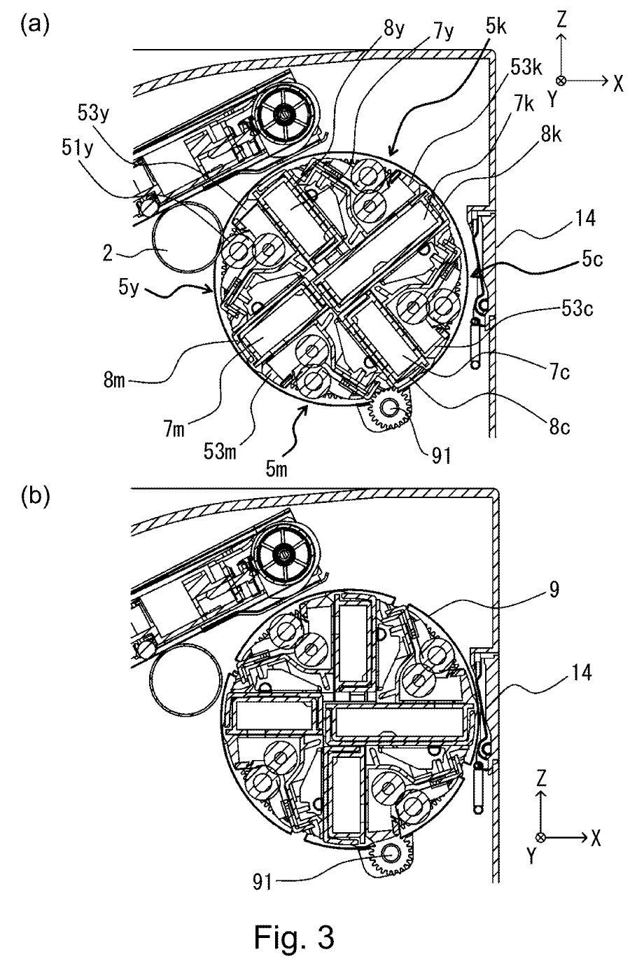

Using FIGS. 1 and 2, a schematic configuration and an image forming operation of the color laser beam printer will be described. FIG. 1 is a schematic sectional view of the color laser beam printer. As shown in FIG. 1, the printer main body 1 includes the rotary 9 and a frame 16 accommodating the rotary 9. The frame 16 is a casing (framework) of the printer main body 1, constituted by a frame or an outer casing member, and has a substantially rectangular parallelopiped shape. The frame 16 is provided with an opening 16a. Specifically, the frame 16 is provided with a side surface 16b extending in a direction crossing the horizontal direction. The side surface 16b constitutes at least a part of an outer appearance surface of the printer main body 1 on the +X side. The opening 16a is disposed in this side surface 16b. The side surface 16b is a side surface disposed on a side downstream of a discharge opening with respect to a discharging direction in which a sheet S on which an image is formed is discharged through the discharge opening of the printer main body 1. A user is capable of supplying sheets S and acquiring the sheet(s) S by accessing a sheet accommodating portion 300 from a side of the side surface 16b of the printer main body 1. For this reason, the side surface 16b can be said as a front surface of the printer main body 1.

As shown in FIG. 1, the printer main body 1 as the image forming apparatus includes a photosensitive drum 2 as a drum-shaped electrophotographic photosensitive member. At a periphery of the photosensitive drum 2, a charging roller 3, an exposure device 4, four developing units 5y, 5m, 5c, and 5k, and a cleaning unit 6 are provided. Here, symbols "y,m, c, and k" represent colors of yellow, magenta, cyan, and black, respectively. In the following, reference numerals or symbols such as "5y, 5m, 5c, and 5k" are presented as "5y to 5k" in some instances. Further, particularly, in the case where there is no need to specify the colors, the reference numerals or symbols is simply represented by "5" in some instances. The charging roller 3 is a charging means for electrically charging the photosensitive drum 2 uniformly. The exposure device 4 is an exposure means for irradiating the photosensitive drum 2 with laser light depending on image information. The exposure device 4 forms an electrostatic latent image on the photosensitive drum 2 by irradiating the charged photosensitive drum 2 with the laser light. The developing units 5y to 5k are developing means for visualizing the electrostatic latent image formed on the photosensitive drum 2, by developing the electrostatic latent image with toner of corresponding colors. The cleaning unit 6 is a cleaning means for removing toner remaining on the surface of the photosensitive drum 2.

The developing units 5y to 5k include developing rollers 51y to 51k and supplying rollers 52y to 52k. Further, to the developing units 5y to 5k, toner cartridges 7y to 7k are mounted. The toner cartridges 7y,7m,7c, and 7k accommodate a yellow toner, a magenta toner, a cyan toner, and a black toner, respectively. That is, the developing units 5y to 5k develop the electrostatic latent image, formed on the photosensitive drum 2, with the yellow toner, the magenta toner, the cyan toner, and the black toner, respectively. Here, the four developing units 5y to 5k are provided in the rotary 9 which is a rotatable rotation supporting member. In addition, the rotary 9 is provided with trays 8y to 8k, and the toner cartridges 7y to 7k are held so as to be detachably mountable to the trays 8y to 8k, respectively. Although as described later, the trays 8y to 8k are supported so as to be slidable and movable to an outside (outer side) of the rotary 9. The trays 8y to 8k (and the toner cartridges 7y to 7k held by the trays 8y to 8k) are slid and moved to the outside of the rotary 9, whereby the toner cartridges 7y to 7k have a configuration in which each of the toner cartridges 7y to 7k is detachably mountable to the rotary 9.

The toner cartridge 7y is an example of a first toner cartridge. The toner cartridge 7c is an example of a second toner cartridge. The toner cartridge 7m is an example of a third toner cartridge. The toner cartridge 7k is an example of a fourth toner cartridge. The developing roller 51y is an example of a first developing roller. The developing roller 51c is an example of a second developing roller. The developing roller 51m is an example of a third developing roller. The developing roller 51k is an example of a fourth developing roller. The developing unit 5y is an example of a first developing device accommodating the toner supplied from the first toner cartridge and including the first developing roller. The developing unit 5c is an example of a second developing device accommodating the toner supplied from the second toner cartridge and including the second developing roller. The developing unit 5m is an example of a third developing device accommodating the toner supplied from the third toner cartridge and including the third developing roller. The developing unit 5k is an example of a fourth developing device accommodating the toner supplied from the fourth toner cartridge and including the fourth developing roller. The rotary 9 is an example of a rotary to which the first to fourth toner cartridges are detachably mountable. The rotary 9 can also be said as an example of a rotary to which the first toner cartridge and the second toner cartridge are detachably mountable. In addition, the rotary 9 is an example of a rotary including the first to fourth developing devices and disposed so that each of the first to fourth developing rollers is rotatable so as to oppose the photosensitive drum 2. The rotary 9 can also be said as an example of a rotary including the first developing device and the second developing device and disposed so that each of the first developing roller and the second developing roller is rotatable so as to oppose the photosensitive drum 2.

Incidentally, in this embodiment, numbering such as a first, second, ... is merely used conveniently for explanation, and can be appropriately replaced in principle.

### Supply of toner from toner cartridge to developing unit

In the following description, a position where mounting of the toner cartridge 7y to the developing unit 5y through the opening 16a is permitted by rotation of the rotary 9 is referred to as a first exchange position. A position where mounting of the toner cartridge 7c to the developing unit 5c through the opening 16a is permitted by rotation of the rotary 9 is referred to as a second exchange position. In the case where there is no need to particularly distinguish the colors, these positions are referred to as an exchange position P1.

FIG. 2 is a conceptual illustration showing a configuration for supplying the toner from the toner cartridge 7 to the developing unit 5. A toner frame 75 of the toner cartridge 7 is provided with a toner accommodating portion 710 and a discharge opening 711 communicating with the toner accommodating portion 710. A developing (unit) frame 53 (53y to 53k) (see part (a) of FIG. 3) of the developing unit 5 is provided with a development-side accommodating portion 530 and a receiving opening 531 communicating with the development-side accommodating portion 530. As described later, in a state in which the toner cartridge 7 is moved to a mounting position, the discharge opening 711 opposes the receiving opening 531. The toner cartridge 7 includes an unshown toner-side sealing member covering the discharge opening 711, and the developing unit 5 includes an unshown development-side sealing member covering the receiving opening 531. Each of the toner-side sealing member and a development-side sealing member is released from sealing thereof, so that each of the discharge opening 711 and the receiving opening 531 is open. In this state, when the rotary 9 is rotated relative to the exchange position P1 of the toner cartridge 7 by an angle larger than an angle α (predetermined angle) shown in FIG. 2, the toner accommodated in the toner accommodating portion 710 is discharged through the discharge opening 711, and the toner discharged through the discharge opening 711enters the development-side accommodating portion 530 through the receiving opening 531, so that the toner is started to be supplied from the toner cartridge 7 to the developing unit 5. In a state in which the toner cartridge 7 is not mounted to the developing unit 5, the discharge opening 711 is covered with the toner-side sealing member and the receiving opening 531 is covered with the development-side sealing member so as to suppress discharge of the toner through the discharge opening 711 and the receiving opening 531.

### Image forming operation of image forming apparatus

Using FIG. 1, an image forming operation in the embodiment 1 will be described. First, the photosensitive drum 2 is rotated in an arrow direction (counterclockwise direction) of FIG. 1 by being synchronized with rotation of an intermediary transfer belt 10.

Then, a surface of the photosensitive drum 2 is electrically charged uniformly by the charging roller 3. Together with this, laser light irradiation of a yellow image is performed by the exposure device 4, so that an electrostatic latent image for yellow is formed on the photosensitive drum 2.

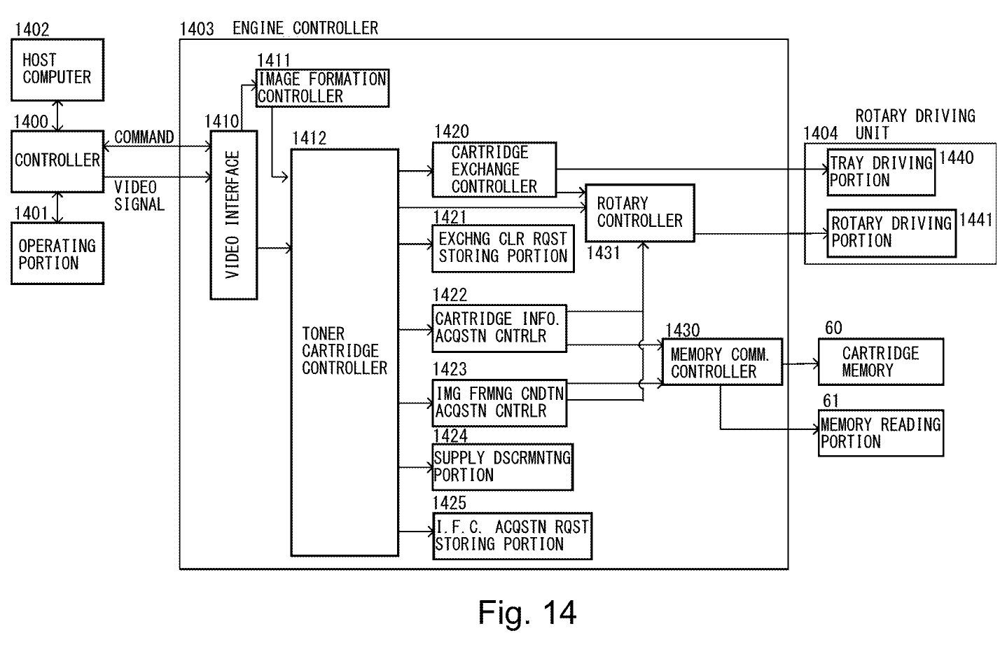

Together with formation of this electrostatic latent image, the rotary 9 is rotated, so that the developing unit 5y for yellow is stopped to a developing position opposing the photosensitive drum 2. Incidentally, the rotary 9 is rotated by a rotary driving portion 1441 (see FIG. 14). In the developing position, the developing roller 51y provided in the developing unit 5y contacts the photosensitive drum 2, so that the electrostatic latent image is developed with the yellow toner. That is, the rotary 9 is rotated in an arrow direction (clockwise direction) of FIG. 1 while supporting the developing units 5y to 5k, whereby the supported four developing units 5y to 5k are successively moved one by one to the developing position opposing the photosensitive drum 2. The developing unit 5 positioned in the developing position develops the electrostatic latent image, formed on the photosensitive drum 2, depending on the color of the toner accommodated thereon. Incidentally, in FIG. 1, the developing roller 51k for black contacts the photosensitive drum 2.

After the electrostatic latent image is developed, the yellow toner formed on the photosensitive drum 2 is transferred (primarily transferred) onto the intermediary transfer belt 10 by a primary transfer roller 11 provided inside the intermediary transfer belt 10. Thus, the primary transfer of the yellow toner image is ended. Then, the developing units 5m, 5c, and 5k for magenta, cyan, and black are successively rotated and moved by rotation of the rotary 9, so that the associated developing unit 5 is stopped in the developing position opposing the photosensitive drum 2. Then, similarly as in the case of the yellow, with respect to each of the colors of the magenta, the cyan, and the black, the formation of the electrostatic latent image, the development of the electrostatic latent image, and the primary transfer of the associated toner image are successively performed. By this, the toner images of the four colors are superposed on the intermediary transfer belt 10. During this period, a secondary transfer roller 12 does not contact the intermediary transfer belt 10. Further, at this time, a cleaning device 13 for removing residual toner on the intermediary transfer belt 10 also does not contact the intermediary transfer belt 10.

On the other hand, the sheets S as a recording material are stacked and accommodated in the sheet accommodating portion 300 provided in a lower portion of the printer main body 1. The sheets S are fed by a pick roller 310. After the sheets S are separated one by one by a feed roller 311 and a separation roller 312, and the separated sheet S is sent to a conveying roller pair 320. The conveying roller pair 320 sends the fed sheet S to a nip (secondary transfer portion) between the intermediary transfer belt 10 and the secondary transfer roller 12. The four color toner images superposed on the intermediary transfer belt 10 are transferred (secondarily transferred) collectively onto the surface of the conveyed sheet S.

The sheet S on which the toner images are transferred is sent to a fixing device 40. In the fixing device 40, the sheet S is heated and pressed, so that an unfixed toner image is fixed on the sheet S. By this, a color image is formed on the sheet S. Then, this sheet S is discharged from the fixing device 40.

As described above, in the image forming operation in the embodiment 1, an image forming unit including the photosensitive drum 2, the developing roller 51, the intermediary transfer belt 10, and the like, a sheet (paper) feeding/conveying unit including the pick roller 310, the feed roller 311, the conveying roller pair 320, and the like, and the fixing device 40 are rotated by an unshown driving source.

### Rotary configuration

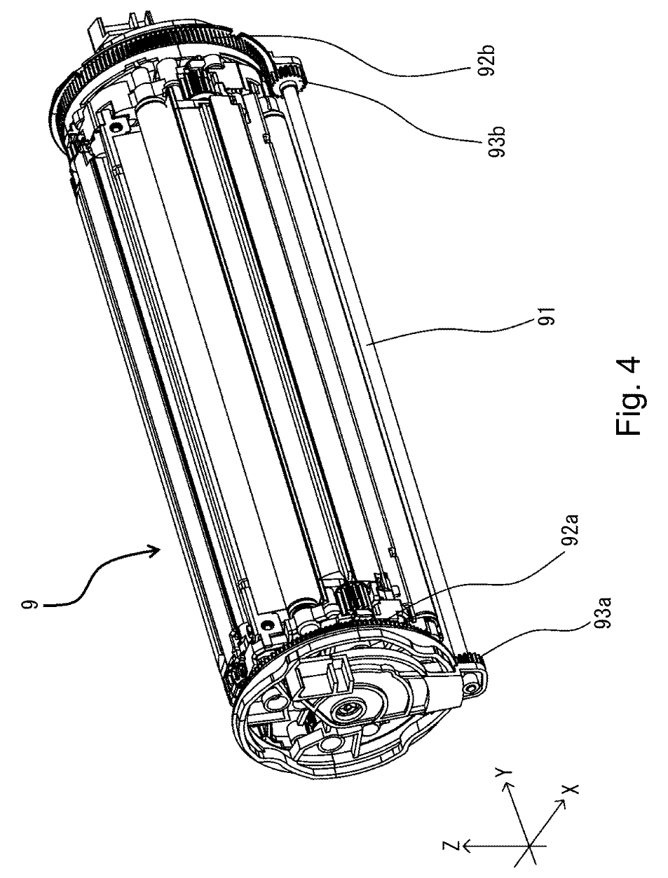

Using FIGS. 3 and 4, a configuration of the rotary 9 will be described. Parts (a) and (b) of FIG. 3 are sectional views of the rotary 9 and a periphery thereof. FIG. 4 is a schematic view of an outer appearance of the rotary 9. As described above, the toner cartridges 7y to 7k are detachably mountable to the rotary 9, and when the toner in each of the toner cartridges 7y to 7k is used up, the user is capable of exchanging the associated one of the toner cartridges 7y to 7k. During exchange of the toner cartridges 7y to 7k, the rotary 9 is stopped in an exchange position.

Part (a) of FIG. 3 shows a cross section of the rotary 9 and the periphery thereof in a state in which the associated developing roller is stopped in the developing position, and as an example, the developing roller 51y for yellow contacts the photosensitive drum 2. Part (b) of FIG. 3 shows a cross section of the rotary 9 and the periphery thereof in a state in which the associated toner cartridge is stopped in an exchange position, and as an exchange, the toner cartridge 7k for black is stopped in the exchange position. As shown in parts (a) and (b) of FIG. 3, in the rotary 9, the four trays 8y to 8k are disposed, and the toner cartridges 7y to 7k are held by the trays 8y to 8k, respectively. At this time, a state in which the toner cartridges 7y to 7k are mounted to the developing units 5y to 5k, respectively, is formed. In the embodiment 1, the toner cartridge 7k accommodating the black toner is larger in size than each of the toner cartridges 7y, 7m, and 7c accommodating the yellow toner, the magenta toner, and the cyan toner, and is capable of accommodating the toner in a larger amount than each of the toner cartridges 7y, 7m, and 7c. For that reason, the tray 8k holding the toner cartridge 7k for black is larger in size than each of the trays 8y, 8m, and 8c holding the toner cartridge 7y for yellow, the toner cartridge 7m for magenta, and the toner cartridge 7c for cyan, respectively. That is, in the rotary 9, the four toner cartridges 7y to 7k different in size and the four trays 8y to 8k different in size are disposed.

Here, the rotary 9 is supported swingably about a swing shaft 91. In the developing position, the rotary 9 is urged by an unshown urging member, whereby the developing roller 51y contacts the photosensitive drum 2. In a process in which the rotary 9 is rotated in the clockwise direction in part (a) of FIG. 3 and is moved to the exchange position, the rotary 9 is swung about a swing shaft 91 by an unshown separation (spacing) mechanism, so that the developing roller 51y is separated from the photosensitive drum 2. In the exchange position, the toner cartridge 7k is stopped in a position opposing a door 14 provided at the front surface of the printer main body 1 (part (b) of FIG. 3). Further, the developing rollers 51y to 51k are separated from the photosensitive drum 2. In this state, the tray 8k is slid and moved from a mounting position of the developing unit 5k to an outside of the rotary 9, so that the user is capable of exchanging the toner cartridge 7k.

Incidentally, in this embodiment, the developing position for the developing unit 5y and the exchange position for the toner cartridge 7k were described, but the same applied to the developing position for the developing units 5m, 5c, and 5k and the exchange position for the toner cartridges 7y, 7m, and 7c. Incidentally, an exchange (exchanging) operation of the toner cartridges 7y to 7k will be described later.

Using FIG. 4, rotational drive of the rotary 9 will be described. As shown in FIG. 4, disk gears 92a and 92b are formed in opposite end portions of the rotary 9 with respect to a longitudinal direction of the rotary 9. Further, the opposite end portions of the swing shaft 91 with respect to a longitudinal direction of the swing shaft 91, driving gears 93a and 93b are connected so as to be capable of being drive-transmitted. Here, a driving force of the rotary driving portion 1441 (first driving source) is transmitted to the driving gear 93b, and is transmitted to the disk gears 92a and 92b by the driving gears 93a and 93b, whereby the rotary 9 is rotated.

### Exchange operation of toner cartridge

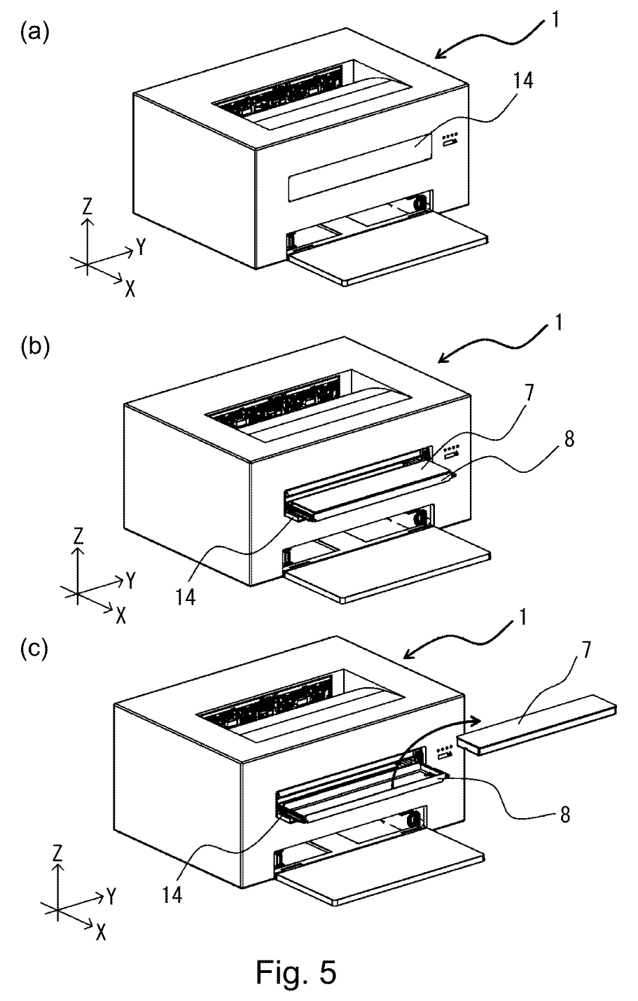

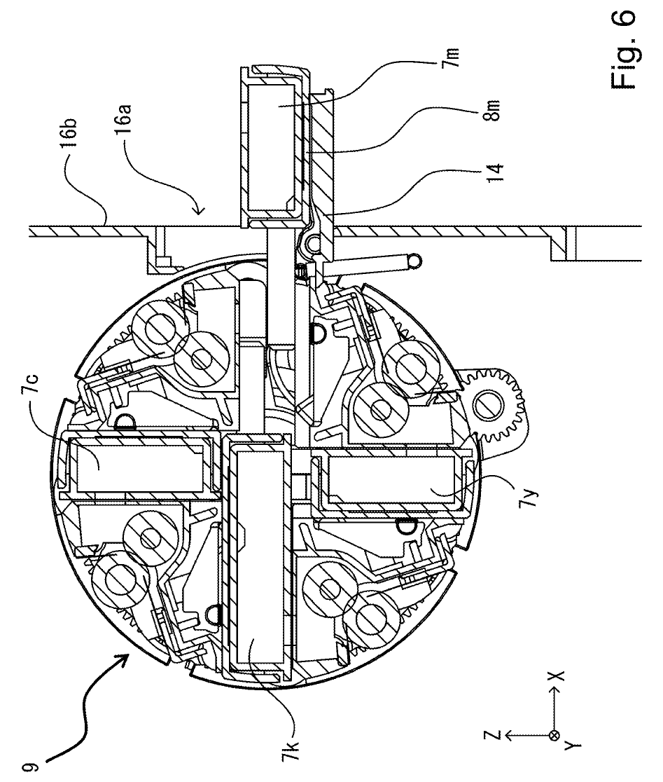

The exchange operation of the toner cartridges 7y to 7k will be described by using FIGS. 5 and 6.

Parts (a) to (c) of FIG. 5 are schematic views of an outer appearance of the printer main body 1. FIG. 6 is a sectional view of the rotary 9 and a periphery thereof.

Part (a) of FIG. 5 shows the outer appearance of the printer main body 1 during the image forming operation and in a stand-by state. At this time, the door 14 is in a closed state. Part (b) of FIG. 5 shows the outer appearance of the printer main body 1 during exchange of the toner cartridges 7y to 7k. At this time, the door 14 is in an open state, and the tray 8 and the toner cartridge 7 are moved to the outside of the printer main body 1.

The exchange operation of the toner cartridges 7y to 7k will be described. First, when the user provides an instruction of an associated one of the toner cartridges 7y to 7k to the printer main body 1, the rotary 9 is rotated to the exchange position of the associated toner cartridge 7 to be exchanged (toner cartridge 7 in which the toner is used up), and is stopped at the exchange position. Here, "the user provides an instruction" means that the user performs an operation such that the user pushes an exchange button provided to the printer main body 1, for example.

Next, the tray 8 and the toner cartridge 7 are slid and moved from the mounting position to the developing unit 5 to the outside of the printer main body 1 by a tray driving portion 1440 (see FIG. 14). At this time, the door 14 is rotatably supported relative to the printer main body 1, and the door 14 is put in the open state by slide-movement of the tray 8 (state of part (b) of FIG. 5). Here, the toner cartridge 7 is held by the tray 8 so as to be detachably mountable to the tray 8, and therefore, as shown in part (c) of FIG. 5, the user is capable of performing the exchange operation by removing (detaching) the toner cartridge 7 from the tray 8 and then by mounting a new toner cartridge 7 to the tray 8. Incidentally, in the case where a plurality of toner cartridges 7 are exchanged, the exchange operation can be performed by repeating the above-described operation.

FIG. 6 shows a cross section of the rotary 9 and the periphery thereof during the exchange of the toner cartridges 7y to 7k, and as an example, the tray 8m and the toner cartridge 7m are slid and moved to the outside of the printer main body 1. As shown in FIG. 6, during the exchange of the toner cartridges 7y to 7k, the user performs a demounting/mounting operation of the toner cartridge 7 from/to the tray 8, and therefore, it is desirable that a whole of the toner cartridge 7 is exposed from the front surface of the printer main body 1.

### Tray arrangement of rotary

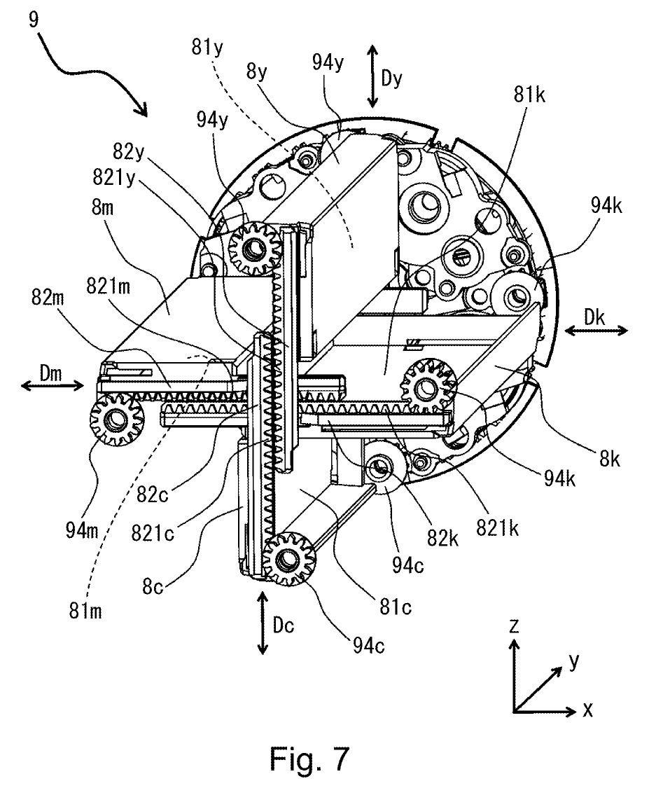

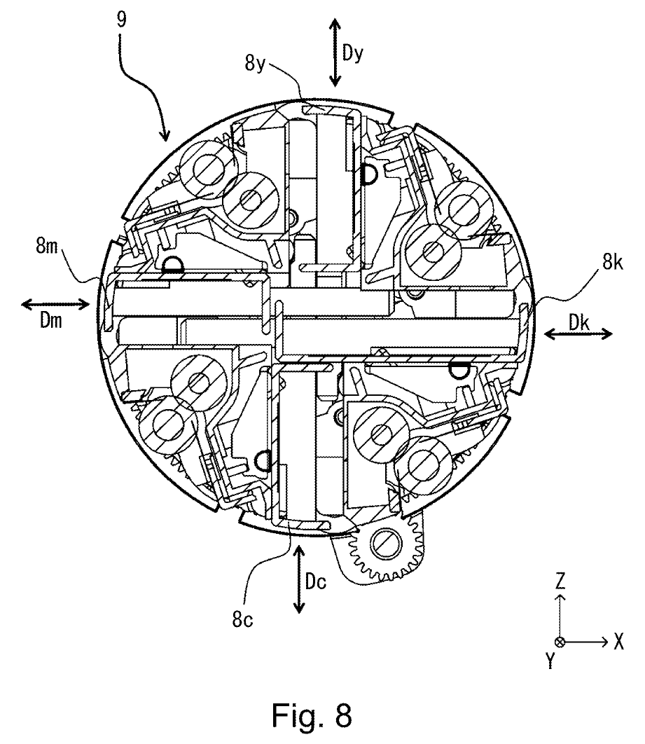

Using FIGS. 7 and 8, an arrangement of the trays 8y to 8k in the rotary 9 will be described. FIG. 7 is a perspective view showing the arrangement of the trays 8y to 8k in the rotary 9. FIG. 8 is a sectional view showing the arrangement of the trays 8y to 8k in the rotary 9.

As shown in FIG. 7, the trays 8y to 8k are provided with holding portions 81y to 81k and tray rails 82y to 82k for the toner cartridges 7y to 7k (not shown in FIG. 7). The tray rails 82y to 82k are provided in each of opposite portions, with respect to the longitudinal direction, sandwiching the holding portions 81y to 81k, therebetween. The tray rails 82y to 82k are provided with rack portions 821y to 821k formed in each of opposite portions with respect to the longitudinal direction. Further, in the rotary 9, rack gears 94y to 94k are rotatably held, so that the rack gears 94y to 94k engage with the rack portions 821y to 821k, respectively, so as to be drive-transmittable.

Further, as shown in FIGS. 7 and 8, in the rotary 9, the four trays 8y to 8k are superposedly arranged. Insertion/extraction directions of the trays 8y to 8k are directions (double-pointed arrow directions in FIGS. 7 and 8) each rotated from an upstream direction with respect to a rotational direction by 90°. For that reason, each of the tray 8y for yellow, the tray 8c for cyan, the tray 8m for magenta, and the tray 8k for black is held slidably and movably in the same direction.

### Drive configuration of insertion/extraction of tray

Using FIGS. 9 and 10, drive configuration of insertion/extraction of the trays 8y to 8k disposed in the rotary 9 will be described. Parts (a) and (b) of FIG. 9 are perspective views showing the drive configuration of insertion/extraction of the trays 8y to 8k. Parts (a) and (b) of FIG. 10 are sectional views showing the drive configuration of insertion/extraction of the trays 8y to 8k. In the following description, of the four trays 8y to 8k, the tray 8k is described as an example, but the same also applies to the drive configuration of insertion/extraction of each of the trays 8y, 8m, and 8c.

Part (a) of FIG. 9 shows a state in which the tray 8k is disposed inside the rotary 9 (i.e., shows a state in which the toner cartridge 7k is mounted to the developing unit 5k). Part (b) of FIG. 9 shows a state in which the tray 8k is slid and moved to the outside of the rotary 9. As described above, two rack portions 821k are formed in the opposite end portions with respect to the longitudinal direction. Further, the rack gear 94k and a driving rack 15 are also provided in each of positions corresponding to the rack portions 821k of the opposite end portions with respect to the longitudinal direction. The tray 8k is held by the rotary 9 so as to be slidably movable relative to the rotary 9 in a direction parallel to the tray rail 82k. The driving rack 15 is held by the rotary 9 so as to be slidably movable relative to the rotary 9 in a vertical direction (Z direction).

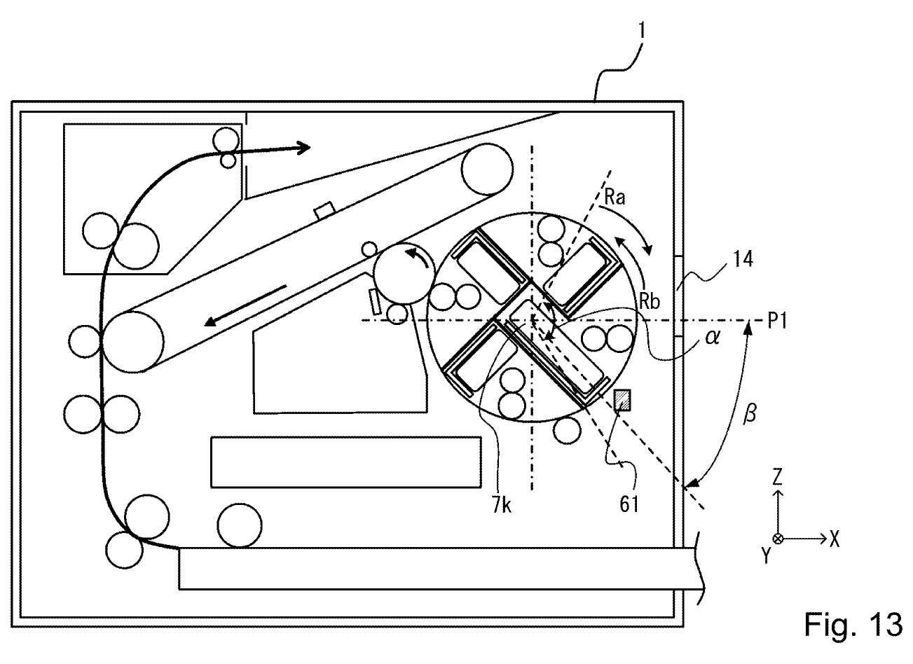

Using parts (a) and (b) of FIG. 10, an insertion/extraction operation of the tray 8k in which the tray 8k is slid and moved from an inside (position where the toner cartridge 7k is mounted to the developing unit 5k) will be described. The insertion/extraction operation is performed by the tray driving portion 1440 (second driving source) (see FIG. 13), the driving rack 15, the rack gear 94k, and the rack portion 821k. First, by the driving force transmitted by the tray driving portion 1440, the driving rack 15 is slid and moved in an upward direction of the printer main body 1, so that the driving force (drive) is transmitted to the rack gear 94k. The rack gear 94k is rotated in the counterclockwise direction, and the drive is transmitted to the rack portion 821k, whereby the tray 8k is slid and moved from the mounting position of the toner cartridge 7k to the developing unit 5k to the outside of the rotary 9.

Further, after the exchange of the toner cartridge 7k, an operation for sliding and moving the tray 8k to be inside of the rotary 9 (to a position where the toner cartridge 7k is mounted to the developing unit 5k) can be performed in the following manner. That is, this operation can be performed by rotationally driving the tray driving portion 1440 in a direction opposite to the direction when the tray 8k is slid and moved to the outside of the rotary 9. In this case, the driving rack 15 is slid and moved in a downward direction of the printer main body 1, so that the tray 8k is drawn into the inside of the rotary 9.

As described above, the insertion/extraction operation of the tray 8k disposed inside the rotary 9 can be performed by the tray driving portion 1440.

The rotary 9 includes first to fourth trays to which the first to fourth toner cartridges are detachably mountable.

The rotary 9 can also be said that the rotary 9 includes the first tray to which the first toner cartridge is detachably mountable and includes the second tray to which the second toner cartridge is detachably mountable. The tray 8y is an example of the first tray, and the tray 8c is an example of the second tray. In the case where a toner cartridge controller 1412 described later receives an exchange request of the first toner cartridge and the second toner cartridge, the toner cartridge controller 1412 performs an operation for moving the first tray to an outside of the main body through the opening 16a after a first exchange preparation operation. Further, the toner cartridge controller 1412 performs an operation for moving the second tray to the outside of the main body through the opening 16a after a second exchange preparation operation.

### Cartridge memory and reading portion

Parts (a) and (b) of FIG. 11 are perspective views showing a configuration of a cartridge memory 60 (storing portion, first storing portion) of the toner cartridge 7 and a cartridge memory reading portion 61 (hereinafter, referred to as a reading portion 61) for reading information recorded in the cartridge memory 60. Hereinafter, the cartridge memory 60 is referred to as a memory 60. In addition, when the memory 60 of each of the toner cartridges 7, the memory 60 is represented in the following manner. The memory of the toner cartridge 7y for yellow is represented by the memory 60y, the memory of the toner cartridge 7m for magenta is represented by the memory 60m, the memory of the toner cartridge 7c for cyan is represented by the memory 60c, and the memory of the toner cartridge 7k for black is represented by the memory 60k. The memory 60y is an example of a first storing portion. The memory 60c is an example of a second storing portion. The memory 60m is an example of a third storing portion. The memory 60k is an example of a fourth storing portion.

As described above, a cartridge memory communication controller 1430 (see FIG. 13) of an engine controller 1403 accesses the memory 60 through the reading portion 61 and reads information stored in the memory 60. That is, the reading portion 61 electrically connects the memory 60 and the cartridge memory communication controller 1430. In the following description, reading of information stored in the memory 60 through the reading portion 61 by the cartridge memory communication controller 1430 is called as reading of the memory 60 by the reading portion 61 in some instances.

Each of the memory 60 and the reading portion 61 is provided with an electrically connectable contact configuration.

The memory 60 is held on a side surface of the toner cartridge 7 with respect to the longitudinal direction, and is disposed in a position where the memory 60 is connectable to the reading portion 61 in a state in which the toner cartridge 7 is accommodated in the rotary 9. The reading portion 61 is retracted to a position where rotation of the rotary 9 is not hindered, and is contacted to a contact portion of the memory 60 when information is acquired from the memory 60. A retracting operation and a contact operation of the reading portion 61 are performed by an unshown driving source.

### Information stored in memory 60

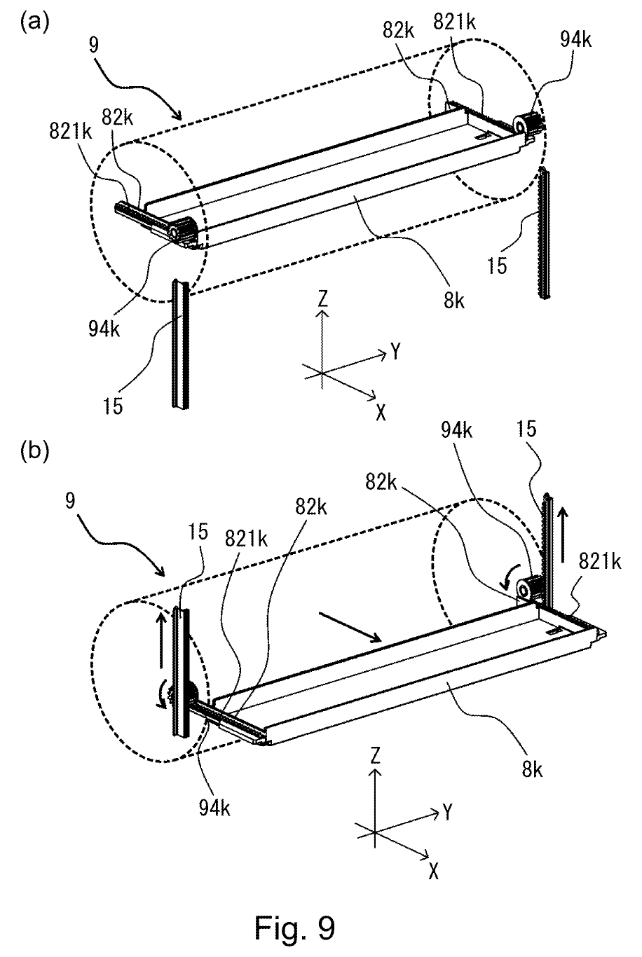

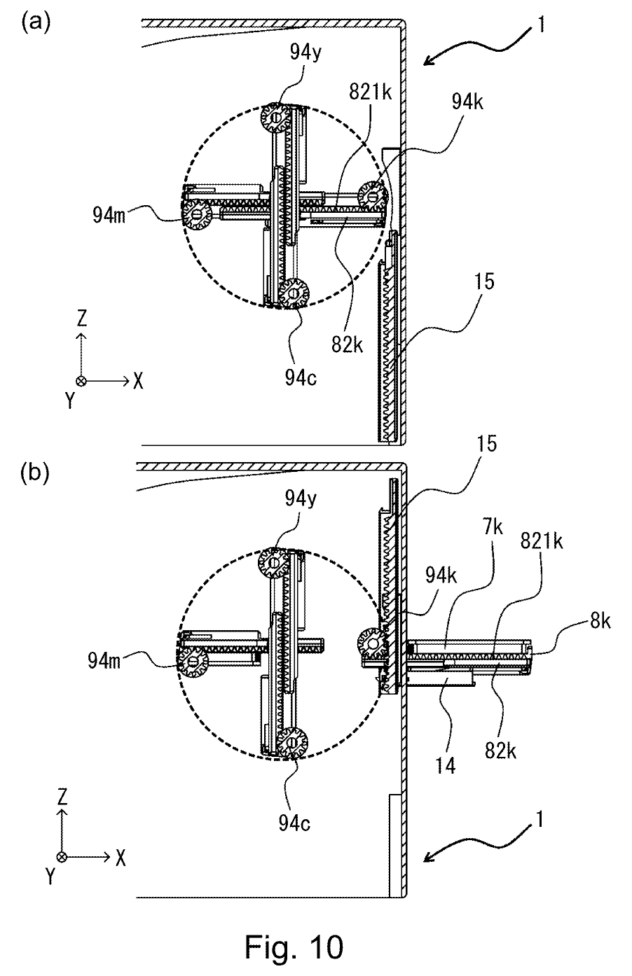

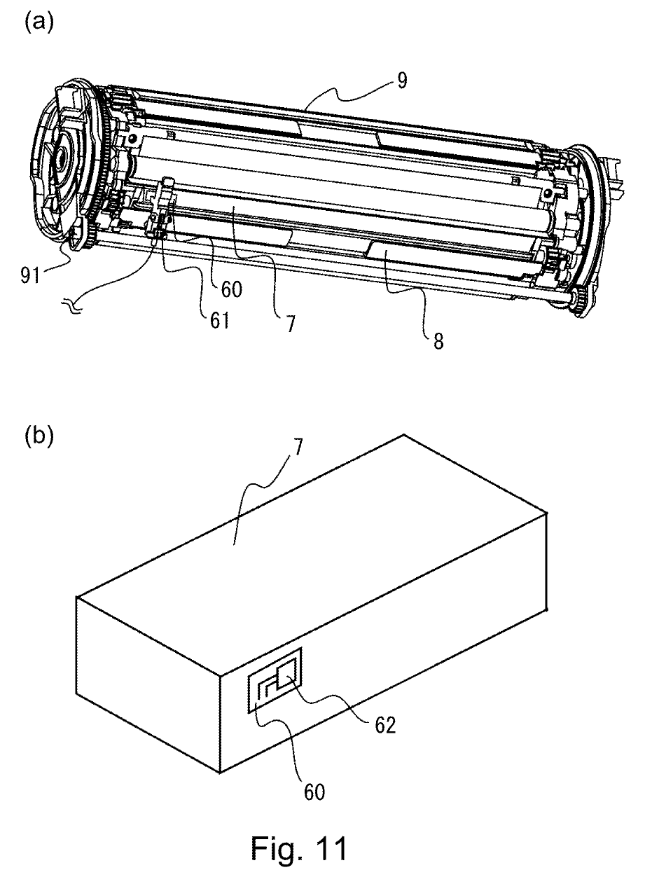

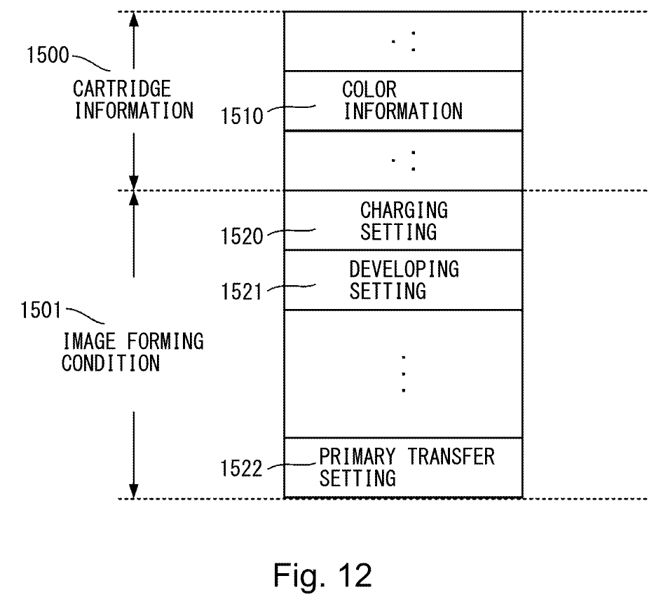

As shown in part (b) of FIG. 11, the memory 60 is prepared by mounting a storing device 62, for storing cartridge information 1500 and information related to an image forming condition 1501 which are shown in FIG. 12, on a substrate. The cartridge information 1500 is an example of first information, and the information related to the image forming condition 1501 is an example of second information. In the embodiment 1, a configuration in which the contact of the reading portion 61 is connected to a wiring pattern is employed, but the contact portion may also be constituted by using a lead wire or the like. Further, the reading portion 61 is connected to an unshown control substrate.

Here, in the cartridge information 1500, color information (first color information) of the toner cartridges 7y to 7k is included. In the image forming condition 1501, a charging setting 1520 relating to charging processing by the charging roller 3, a developing setting 1521 relating to developing processing by the developing roller 51, a primary transfer setting 1522 relating to primary transfer processing by the primary transfer roller 11 are included.

### Arrangement of reading portion and reading operation

In FIG. 13, an arrangement of the reading portion 61 of the printer main body 1 is shown. As described in FIG. 2, in the case where the rotation angle of the rotary 9 becomes the rotation angle larger than the angle α in FIG. 2, the toner is supplied from the toner cartridge 7 to the developing unit 5. In the embodiment 1, the reading portion 61 is disposed in a position where the rotary 9 is rotated relative to the exchange position P1 of the toner cartridge 7 by an angle β in a rotational direction Ra (clockwise direction). The angle β is an angle within the angle α at which the toner is not supplied from the toner cartridge 7 to the developing unit 5 (angle β) < (angle α/2). In the following, a position where the rotary 9 is rotated relative to the exchange position P1 by the angle β in the rotational direction Ra (clockwise direction) is represented by a memory access position (reading position) of the toner cartridge 7. Specifically, the memory access position of the toner cartridge 7y is referred to as a Y memory access position, and the memory access position of the toner cartridge 7m is referred to as an M memory access position. Further, the memory access position of the toner cartridge 7c is referred to as a C memory access position. Further, the memory access position of the toner cartridge 7k is referred to as a K memory access position. The memory access position is an example of a position of the rotary 9 where the first reading operation described later is permitted, and is an example of a first reading position. The C memory access position is an example of a position of the rotary 9 where the second reading operation described later is permitted, and is an example of a second reading position.

Next, the reading operation of the memory 60 through the reading portion will be described. When the toner cartridge 7 is exchanged, the rotary 9 is rotated in the rotational direction Ra (clockwise direction). At this time, the reading portion 61 is retracted from the rotary 9. The rotational direction is the same as the rotational direction during normal image formation. The rotary 9 is stopped in a position, which is a position where the memory 60 and the reading portion 61 oppose each other, and where the rotary 9 is rotated from the exchange position P1 by the angle β. After the rotary 9 is stopped, the reading portion 61 is contacted to the contact portion of the memory 60 and is electrically connected to the memory 60. After reading of information in the memory 60 is made through the reading portion 61, the reading portion 61 is retracted from the memory 60.

Incidentally, the reading portion 61 may also be disposed on a side upstream of the exchange position P1 with respect to the rotational direction Ra. In this case, when the toner cartridge 7 is exchanged, the rotary 9 is rotated in a direction opposite to the rotational direction Ra. Also, in this case, after the reading of the information in the memory 60 through the reading portion 61 is made, supply of the toner from the toner cartridge 7 to the developing unit 5 is started.

### Relationship between toner supply position and cartridge exchange position of rotary

Using FIG. 13, a relationship between a toner supply position and the exchange position P1 of the rotary 9 will be described. Incidentally, in FIG. 13, only principal portions are represented by reference numerals or symbols. As described above with reference to FIG. 2, in the case where the rotation angle of the rotary 9 becomes the rotation angle larger than the angle α, the toner is supplied from the toner cartridge 7 to the developing unit 5. As shown in FIG. 13, in the case where the rotary 9 is rotated from the exchange position P1 of the exchanged toner cartridge 7 to an exchange position of the toner cartridge 7 different from the exchanged toner cartridge 7, there is a need to rotate the rotary 9 by an angle larger than an angle α/2 in FIG. 13. For that reason, when the rotary 9 is rotated to the exchange position of the toner cartridge 7 different from that of the executed toner cartridge 7, the toner in the exchanged toner cartridge 7 is supplied to the developing unit 5. For example, in the case where the toner cartridge 7c for cyan is exchanged after the toner cartridge 7y for yellow is exchanged, the exchange position of the toner cartridge 7c for cyan is in a position rotated by 180° relative to the exchange position of the toner cartridge 7y for yellow. For this reason, when the toner cartridge 7c for cyan is moved to the exchange position thereof, the toner in the toner cartridge 7y for yellow is supplied to the developing unit 5y. In the case where exchange of the toner cartridges 7 is repetitively performed, it is preferable that the printer main body 1 discriminates whether or not the toner in the exchanged toner cartridge may be supplied to the developing unit 5 and then that the position of the rotary 9 is rotated to the exchange position of the toner cartridge to be subsequently exchanged.

### Summary of embodiment 1

Characteristic configuration and control of the embodiment 1 will be described. In the embodiment 1, the case where the printer main body 1 received an exchange instruction of a plurality of toner cartridges 7 will be described. The printer main body 1 in this embodiment first acquires the color information 1510 (see FIG. 12) from the memory 60 of the exchanged toner cartridge 7 and then executes an exchanging operation of the toner cartridge to be subsequently exchanged. Then, when the printer main body 1 completes the exchange of all the toner cartridges 7 each for which an exchange request was made from the user, the printer main body 1 acquires the image forming condition 1501 from the memory 60 of the exchanged toner cartridge 7.

### Block diagram in embodiment 1

FIG. 14 is a block diagram of the printer main body 1 of the embodiment 1. A controller 1400 is capable of communicating with each of an operating portion 1401, a host computer 1402, and the engine controller 1403. Incidentally, a function of the engine controller 1403 is realized by one or more CPUs.

Control in the case where the image forming operation is performed will be described. When the controller 1400 receives print data from the user by the host computer (when the print data from the user is inputted to the controller 1400 by the host computer 1402), the controller 1400 develops the print data and converts the print data into image data. When conversion into the image data is completed, the controller 1400 provides an instruction to a video interface portion 1410 to start printing (print). When the video interface 1410 receives a print start instruction from the controller 1400, the video interface transmits the print start instruction to an image formation controller 1411. On the basis of the received print start instruction, the image formation controller 1411 causes the image forming apparatus to form a toner image on the intermediary transfer belt 10 by the above-described image forming operation. At this time, the image formation controller 1411 carries out image formation control on the basis of the image forming condition 1501 acquired by an image forming condition acquisition controller 1423 (hereinafter, referred to as a condition acquisition controller 1423).

### Exchange of toner cartridge

Control of the printer main body 1 for the user to exchange the toner cartridge 7 will be described. When the controller 1400 receives an exchange request of the toner cartridge 7 from the operating portion 1401, the controller 1400 provides an instruction of exchange of the toner cartridge 7 to the engine controller 1403 through a video interface portion 1410. The toner cartridge controller 1412 (controller) of the engine controller 1403 carries out the following control when receives the exchange instruction (exchange request) of the toner cartridge 7 from the video interface portion 1410. That is, the toner cartridge controller 1412 causes an exchange color request storage portion 1421 (storage portion) to store the exchange request of the toner cartridge 7 instructed to be exchanged. The exchange request stored in the exchange color request storage portion 1421 is an example of second color information. The toner cartridge controller 1412 provides an instruction to a toner cartridge exchange controller 1420 to exchange the toner cartridge 7 instructed to be exchanged (hereinafter, this controller is referred to as an exchange controller 1420).

When the exchange instruction of the toner cartridge 7 is provided from the toner cartridge controller 1412, the exchange controller 1420 provides an instruction to a rotary controller 1431 to move the rotary 9 to the exchange position of the exchange-instructed toner cartridge 7. When an instruction to rotate the position of the rotary 9 to the exchange position of the toner cartridge 7 is provided to the rotary controller 1431, the rotary controller 1431 causes a rotary driving portion 1441 of the rotary driving unit 1404 (driving device) to be driven, so that the rotary 9 is rotated. The rotary driving portion 1441 is an example of a driving portion for rotating the rotary 9.

The exchange controller 1420 causes the tray driving portion 1440 to be driven when the rotary 9 is moved to the exchange position of the toner cartridge 7, so that the tray 8 is slid to a position where the user is capable of exchanging the toner cartridge 7. When the printer main body 1 moves the tray 8 to the exchange position, the exchange of the toner cartridge 7 by the user is permitted.

Thereafter, completion of the exchange of the toner cartridge 7 is instructed to the printer main body 1 by the user through the operating portion 1401. When the controller 1400 receives from the operating portion 1401 that the exchange of the toner cartridge is completed, the exchange completion of the toner cartridge 7 is instructed to the engine controller 1403 through the video interface portion 1410 by the controller 1400. When the toner cartridge controller 1412 receives the exchange completion of the toner cartridge 7 through the video interface portion 1410, the exchange completion of the toner cartridge 7 is instructed to the exchange controller 1420 by the toner cartridge controller 1412. When the exchange controller 1420 receives that the exchange of the toner cartridge 7 is completed, the exchange controller 1420 causes the tray driving portion 1440 to be driven, so that the tray 8 is slid to the inside of the rotary 9.

### After exchange of toner cartridge

Control of the printer main body 1 after the exchange of the toner cartridge 7 will be described. The toner cartridge controller 1412 provides an instruction to a cartridge information acquisition controller 1422 (hereinafter, referred to as an information acquisition controller 1422) to acquire the cartridge information 1500 stored in the memory 60 when the toner cartridge 7 is exchanged. In the case where the position of the rotary 9 is not the memory access position, the information acquisition controller 1422 causes the rotary controller 1431 to drive the rotary driving portion 1441 and provides an instruction to rotate the position of the rotary 9 to the memory access position of the toner cartridge 7. When the position of the rotary 9 becomes the memory access position of the toner cartridge 7, the information acquisition controller 1422 causes the cartridge memory communication controller 1430 (hereinafter, referred to as a memory communication controller 1430) to access the memory 60. The memory communication controller 1430 causes the reading portion 61 to read the information stored in the memory 60. Incidentally, the operation of the reading portion 61 is as described with reference to part (a) of FIG. 11.

A supply discriminating portion 1424 is a discriminating portion for discriminating whether or not the toner may be supplied to the developing unit 5 corresponding to the exchange toner cartridge 7. In this embodiment, the supply discriminating portion 1424 discriminates whether or not the toner is capable of being supplied depending on whether or not the color information 1510 of the cartridge information 1500 on the exchanged toner cartridge 7 is the same color as the color of the developing unit 5 as a supply object. Here, "the supply discriminating portion 1424 discriminates that the toner may be supplied" means that "the supply discriminating portion 1424 discriminates that the color information 1510 is the same color as the color of the developing unit 5 as the supply object". Here, "the supply discriminating portion 1424 discriminates that the toner cannot be supplied" means that "the supply discriminating portion 1424 discriminates that the color information 1510 is different from the color of the developing unit 5 as the supply object". After the supply discriminating portion 1424 discriminated that the toner may be supplied, the toner in the exchanged toner cartridge 7 is supplied to the developing unit 5. Further, after the supply discriminating portion 1424 discriminated that the toner may be supplied, the toner cartridge controller 1412 executes the exchange control of the toner cartridge 7 different from the exchanged toner cartridge 7.

When exchange of all the toner cartridges 7, for which exchange requests from the user have been received, is completed, the toner cartridge controller 1412 provides an instruction to the condition acquisition controller 1423 to acquire the image forming condition 1501 stored in the memory 60 of the exchanged toner cartridge 7. That is, in the embodiment 1, a timing when the image forming condition 1501 is acquired is a timing after exchange of all the toner cartridges 7 for which exchange requests have been received is completed. Incidentally, the toner cartridge controller 1412 causes an image forming condition acquisition request storage portion 1425 (hereinafter referred to as a condition acquisition request storage portion 1425) to store an acquisition request of the image forming condition 1501 of the toner cartridge 7.

In the case where the position of the rotary 9 is not the memory access position, the condition acquisition controller 1423 provides an instruction to the rotary controller 1431 to rotate the position of the rotary 9 to the memory access position. The rotary controller 1431 drives the rotary driving portion 1441 and thus rotates the rotary 9. When the position of the rotary 9 becomes the memory access position of the toner cartridge 7, the condition acquisition controller 1423 causes the memory communication controller 1430 to access the memory 60. The memory communication controller 1430 reads information stored in the memory 60 through the reading portion 61. Incidentally, an operation of the reading portion 61 is as described above with reference to part (a) of FIG. 11.

When the supply discriminating portion 1424 discriminates that the toner cannot be supplied, the toner cartridge controller 1412 provides an instruction to the exchange controller 1420 to discharge the toner cartridge 7. When the discharge of the toner cartridge 7 is instructed, the exchange controller 1420 controls the rotary 9 through the rotary controller 1431. The rotary controller 1431 drives the rotary driving portion 1441 to rotate the rotary 9 in a rotational direction Rb (counterclockwise direction, see FIG. 13) so as not to exceed a range of the angle α, so that the toner cartridge 7 is returned to the exchange position. The rotational direction Rb is an example of a rotational direction in which the rotary 9 is rotated after the first reading operation is a direction opposite to the rotational direction Ra which is an example of a rotational direction of the rotary 9 when the rotary 9 is moved from the first exchange position to the first reading position. When the rotary 9 is rotated to the exchange position of the toner cartridge 7, in order to discharge the toner cartridge 7, the exchange controller 1420 causes the tray driving portion 1440 to slide the tray 8 to a position where exchange of the toner cartridge 7 by the user is permitted.

### Description of cartridge memory map in embodiment 1

The memory 60 stores the cartridge information 1500 and the image forming condition 1501. The cartridge information is information at least the color information 1510. The color information 1510 is information indicating either one of yellow, magenta, cyan and black which are toner colors of the toner cartridges 7. The image forming condition 1501 is set values of the image forming operation, such as the charging setting 1520, the developing setting 1521, and the primary transfer setting 1522. The cartridge information 1500 is an example of first information, and the information of the image forming condition 1501 is an example of second information. The second information can be said as information different from the first information. Further, the first information and the second information are read by the engine controller 1403 after the toner cartridge 7 is mounted to the rotary main body 90 and before the image forming operation is executed.

### Description of timing chart of embodiment 1

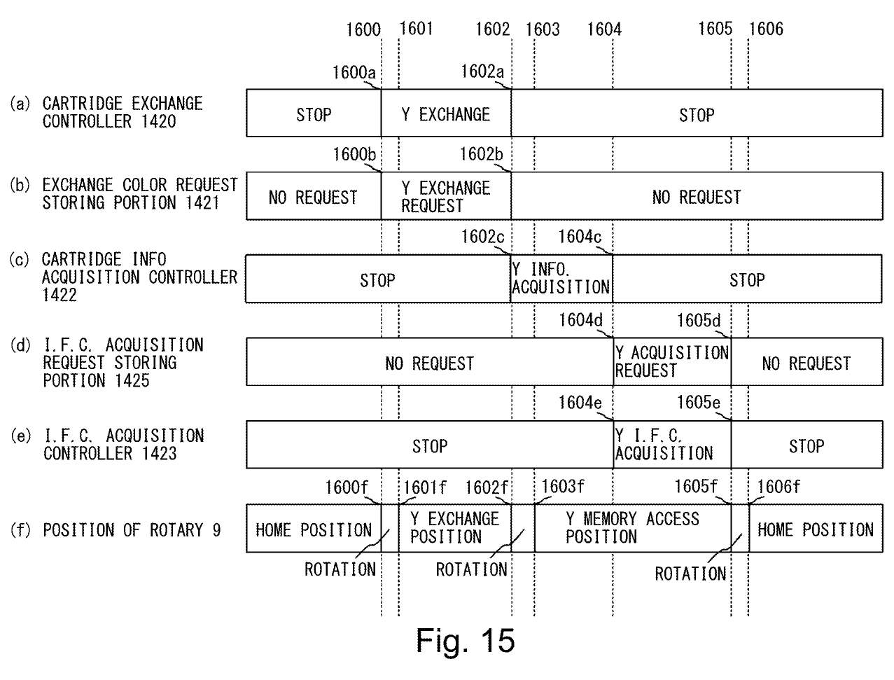

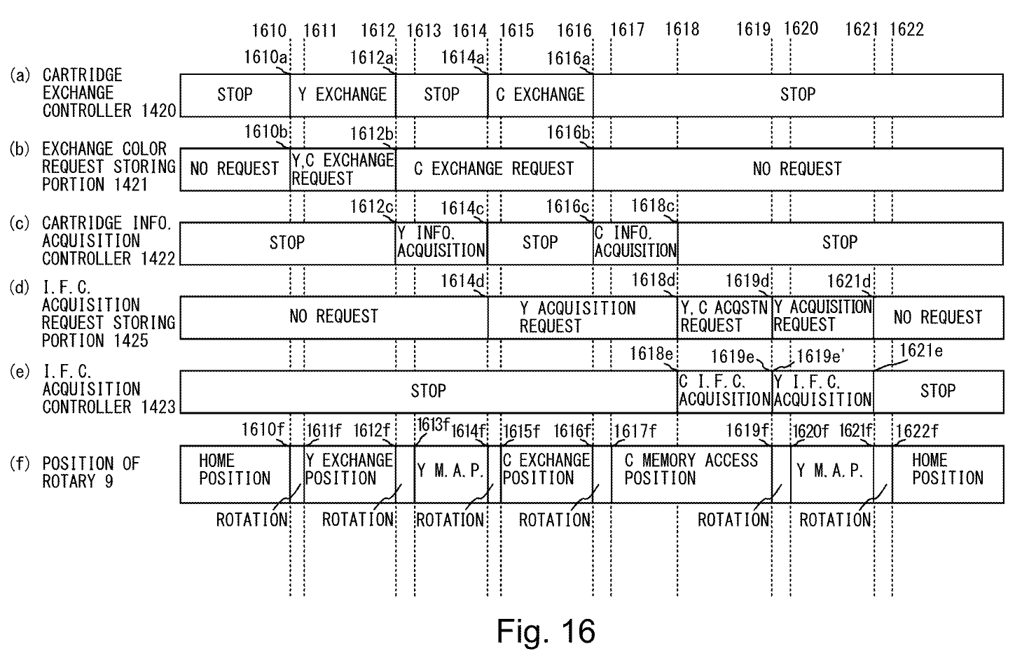

FIGS. 15 and 16 are timing charts during the exchange of the toner cartridge 7 in the embodiment 1.

FIG. 15 is the timing chart in the case where the user exchanges one of the toner cartridges 7. As an example, the case where the toner cartridge 7y for yellow is exchanged (hereinafter referred to as Y exchange) will be described. FIG. 16 is the timing chart in the case where the user exchanges a plurality of the toner cartridges 7. As an example, the case where the toner cartridge 7y for yellow and the toner cartridge 7c for cyan are exchanged will be described. In each of FIGS. 15 and 16, part (a) shows a state of the exchange controller 1420, and part (b) shows a request stored in the exchange color request storage portion 1421.

Further, in each of FIGS. 15 and 16, part (c) shows a state of the information acquisition controller 1422, part (d) shows a request stored in the condition acquisition request storage portion 1425, part (e) shows a state of the condition acquisition controller 1423, and part (f) shows the position of the rotary 9. Incidentally, 1600 to 1606 and 1610 to 1622 show respective timings. The exchange controller 1420, the exchange color request storage portion 1421, the information acquisition controller 1422, the condition acquisition request storage portion 1425, the condition acquisition controller 1423, and the rotary 9 are started from "during stop", "no request", "during stop", "no request", "during stop", and "home position", respectively. The home position of the rotary 9 is a position of the rotary 9 before the print main body 1 starts the printing.

### Case where one (single) toner cartridge is exchanged

First, FIG. 15 will be described. When the toner cartridge controller 1412 receives an exchange instruction of the toner cartridge 7y for yellow through the video interface portion 1410, the toner cartridge controller 1412 provides an instruction to the exchange controller 1420 to exchange the toner cartridge 7y for yellow (1600a). The exchange color request storage portion 1421 stores an exchange request of the toner cartridge 7y for yellow (hereinafter, this request is referred to as "Y exchange request") (second color information). Incidentally, another exchange request is referred to as "M exchange request" in the case of the exchange request of the toner cartridge 7m for magenta, "C exchange request" in the case of the exchange request of the toner cartridge 7c for cyan, and "black exchange request" in the case of the exchange request of the toner cartridge 7k for black.

When the exchange of the toner cartridge 7y for yellow is instructed, the exchange controller 1420 is shifted in state from a state of during stop to a state of exchange of the toner cartridge 7y for yellow (hereinafter, this exchange is referred to as "Y exchange"). Incidentally, the case of exchange instruction of the toner cartridge 7m for magenta is referred to as M exchange, the case of exchange instruction of the toner cartridge 7c for cyan is referred to as C exchange, and the case of exchange instruction of the toner cartridge 7k for black is referred to as K exchange. The exchange controller 1420 provides an instruction to the rotary controller 1431 to rotate the position of the rotary 9 to the exchange position of the toner cartridge 7y for yellow (hereinafter this exchange position is referred to as "Y exchange position") (1600f). The rotary 9 is during rotation, in the rotational direction Ra from the home position toward the Y exchange position, in a period from 1600f to 1601f described later. Incidentally, the exchange position of the toner cartridge 7m for magenta is referred to as an M exchange position, the exchange position of the toner cartridge 7c for cyan is referred to as a C exchange position, and the exchange position of the toner cartridge 7k for black is referred to as a K exchange position.

When the position of the rotary 9 becomes the Y exchange position (1601f), the exchange controller 1420 causes the driving portion to slide the tray 8y to a position where the user is capable of exchanging the toner cartridge 7y for yellow. When the user exchanges the toner cartridge 7y for yellow, the exchange controller 1420 causes the driving portion to slide the tray 8y to the inside of the rotary 9, so that the state of the rotary 9 is shifted from the Y exchange state to the state during stop (1602a). When the toner cartridge 7y for yellow is exchanged, the toner cartridge controller 1412 changes the Y exchange request, stored in the exchange color request storage portion 1421, to no request (1602b). The toner cartridge controller 1412 provides an instruction to the information acquisition controller 1422 to acquire cartridge information 1500 of the exchanged toner cartridge 7y for yellow (1602c).

When acquisition of the cartridge information 1500 of the toner cartridge 7y for yellow is instructed from the toner cartridge controller 1412, the information acquisition controller 1422 shifts in state from the state during stop to a state during information acquisition of the toner cartridge 7y for yellow. In the following, during information acquisition of the toner cartridge 7y for yellow is referred to as during Y information acquisition. Incidentally, during information acquisition of the toner cartridge 7m for magenta is referred to as a during M information acquisition, during information acquisition of the toner cartridge 7c for cyan is referred to as during C information acquisition, and during acquisition of the toner cartridge 7k for black is referred to as during K information acquisition. The information acquisition controller 1422 provides an instruction to the rotary controller 1431 to rotate the position of the rotary 9 to the memory access position (1602f). The state of the rotary 9 is during rotation, in the rotational direction Ra from the Y exchange position toward the memory access position, in a period from 1602f to 1603f described later.

When the position of the rotary becomes the memory access position (1603f), the information acquisition controller 1422 accesses the memory 60. When the information acquisition controller 1422 acquires the cartridge information 1500 (1604c), the state of the information acquisition controller 1422 is shifted from the state of during Y information acquisition to the state during stop. When the information acquisition controller 1422 acquires the cartridge information 1500, by the supply discriminating portion 1424, whether or not the toner in the exchanged toner cartridge 7y for yellow may be supplied to the developing unit 5y is discriminated. The toner cartridge controller 1412 carries out control in the following manner when the supply discriminating portion 1424 discriminated from the color information 1510 that the toner in the toner cartridge 7y is capable of being supplied to the developing unit 5y. That is, the toner cartridge controller 1412 causes the condition acquisition request storage portion 1425 to store an image forming condition acquisition request of the toner cartridge 7y for yellow (hereinafter, this request is referred to as a Y acquisition request) (1604d). Incidentally, an image forming condition acquisition request of the toner cartridge 7m for magenta is referred to as an M acquisition request, an image forming condition acquisition request of the toner cartridge 7c for cyan is referred to as a C acquisition request, and an image forming condition acquisition request of the toner cartridge 7k for black is referred to as a K acquisition request. The toner cartridge controller 1412 provides an instruction to the condition acquisition controller 1423 to acquire the image forming condition 1501 of the toner cartridge 7y for yellow (1604e).

When the acquisition of the image forming condition 1501 of the toner cartridge 7y for yellow is instructed from the toner cartridge controller 1412, the condition acquisition controller 1423 shifts in state from a state of during stop to a state of during acquisition of the image forming condition of the toner cartridge 7y for yellow. Hereinafter, during acquisition of the image forming condition of the toner cartridge 7y for yellow is referred to as during Y image condition acquisition. Incidentally, during acquisition of the image forming condition of the toner cartridge 7m for magenta is referred to as during M image condition acquisition, during acquisition of the image forming condition of the toner cartridge 7c for cyan is referred to as during C image condition acquisition, and during acquisition of the image forming condition of the toner cartridge 7k for black is referred to as during K image condition acquisition. The condition acquisition controller 1423 causes the memory communication controller 1430 to access the memory 60y. When the condition acquisition controller 1423 acquires the image forming condition 1501 (1605e), the condition acquisition controller 1423 shifts in state from the state of during Y image condition acquisition to the state of during stop.

When the condition acquisition controller 1423 acquires the image forming condition 1501 of the toner cartridge 7y for yellow, the toner cartridge controller 1412 changes the Y acquisition request of the condition acquisition request storage portion 1425 to no request (1605d). Finally, the toner cartridge controller 1412 provides an instruction to the rotary controller 1431 to rotate the position of the rotary 9 to the home position (1605f). In a period from 1605f to 1606f described later, the rotary 9 becomes during rotation in the rotational direction Ra from the Y memory access position toward the home position. When the position of the rotary 9 becomes the home position from the Y memory access position, the toner cartridge controller 1412 completes the toner cartridge exchange (1606f).

In case where plurality of toner cartridges are exchanged

Next, FIG. 16 will be described. Toner cartridge controller 1412 receives an exchange instruction of the toner cartridge 7y for yellow and an exchange instruction of the toner cartridge 7c for cyan from the video interface portion 1410. By this, the toner cartridge controller 1412 provides an instruction to the exchange controller 1420 to exchange the toner cartridge 7y for yellow (1610a). The toner cartridge controller 1412 causes the exchange color request storage portion 1421 to store the Y exchange request and the C exchange request (1610b). This state can be said as a state in which mounting of a new toner cartridge 7y and a new toner cartridge 7c to the rotary main body 90 is permitted.

When the exchange of the toner cartridge 7y for yellow is instructed, the exchange controller 1420 shifts in state from a state of during stop to the Y exchange state and provides an instruction to the rotary controller 1431 to rotate the position of the rotary 9 to the Y exchange position (1610f). In a period from 1610f to 1611f described later, the rotary 9 becomes during rotation in the rotational direction Ra from the home position to the Y exchange position.

When the rotary position becomes the Y exchange position (1611f), the exchange controller 1420 causes the driving portion to slide the tray 8y to a position where the user is capable of exchanging the toner cartridge 7y for yellow. When the user exchanges the toner cartridge 7y for yellow, the exchange controller 1420 causes the driving portion to slide the tray 8y to the inside of the rotary 9, so that the state of the rotary 9 is shifted from the Y exchange state to the state during stop (1612a). When the toner cartridge 7y for yellow is exchanged, the toner cartridge controller 1412 causes the exchange color request storage portion 1421 to change the Y exchange request stored therein to no request (to change the Y exchange request to only the C exchange request) (1612b).

The toner cartridge controller 1412 provides an instruction to the information acquisition controller 1422 to acquire cartridge information 1500 of the exchanged toner cartridge 7y for yellow (1612c). When the acquisition of the cartridge information 1500 of the toner cartridge 7y for yellow is instructed from the toner cartridge controller 1412, the information acquisition controller 1422 carries out control in the following manner. That is, the information acquisition controller 1422 provides an instruction to the rotary controller 1431 to rotate the position of the rotary 9 to the Y memory access position (1612f). In a period from 1612f to 1613f described later, the rotary 9 becomes during rotation in the rotational direction Ra from the Y exchange position toward the Y memory access position.

When the position of the rotary 9 becomes the Y memory access position (1613f), the information acquisition controller 1422 causes the memory communication controller 1430 to access the memory 60y. When the information acquisition controller 1422 acquires the cartridge information 1500 (1614c), the toner cartridge controller 1412 causes the supply discriminating portion 1424 to check whether or not the toner in the exchanged toner cartridge 7y for yellow may be supplied to the developing unit 5y. When the toner cartridge controller 1412 discriminates from the color information 1510 that the toner in the toner cartridge 7y for yellow can be supplied to the developing unit 5y, the toner cartridge controller 1412 cases the condition acquisition request storage portion 1425 to store the Y acquisition request (1614d). The toner cartridge controller 1412 checks whether or not there is subsequent exchange request in the exchange color request storage portion 1421.

The toner cartridge controller 1412 provides an instruction to the exchange controller 1420 to exchange the toner cartridge 7c for cyan because the C exchange request is stored in the exchange color request storage portion 1421 (1614a). The exchange controller 1420 shifts in state from the state of during stop to the C exchange state when the exchange of the toner cartridge 7c for cyan is instructed. The exchange controller 1420 provides an instruction to the rotary controller 1431 to rotate the position of the rotary 9 from the Y memory access position to the C exchange position (1614f). In a period from 1614f to 1615f described later, the rotary 9 becomes during rotation in the rotational direction Ra from the Y memory access position toward the C exchange position.

FIG. 16 is an example in which in the case where the toner cartridge controller 1412 receives an exchange request of the first toner cartridge and the second toner cartridge, the toner cartridge controller 1412 performs a first exchange preparation operation, a first reading operation, and a second exchange preparation operation. Here, an operation from 1610f to 1611f is an example of the first exchange preparation operation (the exchange preparation operation) in which the rotary 9 is positioned in the first exchange position by a driving source. An operation from 1612c to 1614c is an example of the first reading operation in which a part of information stored in a first storing portion of the first toner cartridge mounted to the rotary 9 is read by the reading portion. An operation from 1614f to 1615f is an example of the second exchange preparation operation (the exchange preparation operation) in which the rotary 9 is positioned in the second exchange position by the driving source. A rotational direction when the rotary 9 moved from the first reading position to the second exchange position may be opposite to a rotational direction of the rotary 9 from the first exchange position to the first reading position.

Incidentally, in FIG. 16, description was made using an example in which the memory access position is different from the exchange position, but the present disclosure is not limited thereto. There is also a case where the reading portion 61 is disposed in a position where the rotary 9 is capable of accessing the memory 60 in a state in which the rotary 9 takes the exchange position, in other words, there is also a case where the rotary 9 is not required to be rotated from the exchange position to the memory access position. For example, in the case of non-contact memory or the like, there is no need that the memory and the reading portion oppose each other. As in this case, the memory access position may also be the same position as the exchange position.

Further, the color information 1510 of the cartridge information 1500 is an example of information related to a kind of the first toner cartridge read by the first reading operation. The toner cartridge controller 1412 performs the second exchange preparation operation in the case where the supply discriminating portion 1424 discriminated that the kind of the first toner cartridge coincides with a predetermined kind and performs the first exchange preparation operation in the case where the supply discriminating portion 1424 discriminated that the kind of the first toner cartridge is different from the predetermined kind.

Incidentally, the information read by the first reading operation is not limited to the color information 1510 described above. For example, the color information is not limited to the color information 1510, but may also be information relating to prescription (component, characteristic) of the toner.

Further, FIG. 16 is an example in which in the case where the toner cartridge controller 1412 receives the exchange request of the first toner cartridge and the second toner cartridge, the toner cartridge controller 1412 performs the second reading operation. Here, an operation from 1616c to 1618c is an example of the second reading operation in which at least a part of information stored in a second storing portion of the second toner cartridge mounted to the rotary 9 is read through the reading portion 61 after the second exchange preparation operation.

When the rotary position becomes the C exchange position (1615f), the exchange controller 1420 slides the tray 8c to a position where the user can exchange the toner cartridge 7c for cyan. When the user exchanged the toner cartridge 7c for cyan, the exchange controller 1420 slides the tray 8c to the inside of the rotary 9 and shifts in state from the C exchange state to the state during stop (1616a). When the toner cartridge 7c for cyan is exchanged, the toner cartridge controller 1412 changes the C exchange request, stored in the exchange color request storage portion 1421, to no request (1616b). The toner cartridge controller 1412 provides an instruction to the information acquisition controller 1422 to acquire the cartridge information 1500 of the exchanged toner cartridge 7c for cyan (1616c). When the acquisition of the cartridge information 1500 of the toner cartridge 7c for cyan is instructed from the toner cartridge controller 1412, the information acquisition controller 1422 shifts in state from the state during stop to a state during C information acquisition of the toner cartridge 7c for cyan. In the following, during information acquisition of the toner cartridge 7y for yellow is referred to as during Y information acquisition. The information acquisition controller 1422 provides an instruction to the rotary controller 1431 to rotate the position of the rotary 9 to the C memory access position (1616f). The state of the rotary 9 is during rotation in the rotational direction Ra from the C exchange position toward the C memory access position, in a period from 1616f to 1617f described later.

When the position of the rotary becomes the C memory access position (1617f), the information acquisition controller 1422 accesses the memory 60c. When the information acquisition controller 1422 acquires the cartridge information 1500 (1618c), the state of the information acquisition controller 1422 is shifted from the state of during C information acquisition to the state during stop. When the information acquisition controller 1422 acquires the cartridge information 1500, the toner cartridge controller 1412 causes the supply discriminating portion 1424 to discriminate whether or not the toner in the exchanged toner cartridge 7c for cyan may be supplied to the developing unit 5c. When the supply discriminating portion 1424 discriminated from the color information 1510 that the toner in the toner cartridge 7c for cyan can be supplied to the developing unit 5c, the toner cartridge controller 1412 causes the condition acquisition request storage portion 1425 to store the C acquisition request (1618d). Incidentally, at a timing of 1618c, a state in which the Y acquisition request is also stored in the condition acquisition request storage portion 1425 is formed.

The toner cartridge controller 1412 provides an instruction to the condition acquisition controller 1423 to acquire the image forming condition 1501 of the toner cartridge 7c for cyan (1618e). When the acquisition of the information 1501 of the toner cartridge 7c for cyan is instructed from the toner cartridge controller 1412, the condition acquisition controller 1423 shifts in state from the state during stop to the state during the C image condition acquisition. The condition acquisition controller 1423 causes the memory communication controller 1430 to access the memory 60c. When the image forming condition 1501 is acquired (1619e), the condition acquisition controller 1423 shifts in state from the state during the C image condition acquisition to the state during stop.

When the condition acquisition controller 1423 acquires the image forming condition 1501 of the toner cartridge 7c for cyan, the toner cartridge controller 1412 causes the condition acquisition request storage portion 1425 to change the C acquisition request to no request (to store only the Y acquisition request) (1619d). The toner cartridge controller 1412 provides an instruction to the condition acquisition controller 1423 to acquire the image forming condition 1501 of the toner cartridge 7y for yellow (1619e'). When the acquisition of the image forming condition 1501 of the toner cartridge 7y for yellow is instructed from the toner cartridge controller 1412, the condition acquisition controller 1423 shifts in state from the state during stop to the state during the Y image condition acquisition. The condition acquisition controller 1423 provides an instruction to the rotary controller 1431 to rotate the position of the rotary 9 to the Y memory access position (1619f). In a period from 1619f to 1620f descried later, the rotary 9 becomes during rotation in the rotational direction Ra (or the rotational direction Rb) from the C memory access position toward the Y memory access position.

When the position of the rotary 9 becomes the Y memory access position, the condition acquisition controller 1423 causes the memory communication controller 1430 to access the memory 60 (1620f). When the condition acquisition controller 1423 acquires the image forming condition 1501 (1621e), the condition acquisition controller 1423 shifts in state from the state during the Y image condition acquisition to the state during stop.

FIG. 16 is an example in which the toner cartridge controller 1412 performs a third reading operation in the case where the toner cartridge controller 1412 receives the exchange request of the first toner cartridge and the second toner cartridge. An operation from 1619e' to 1621e is an example of the third reading operation (first additional reading operation) in which information different from the information read from the first storing portion by the first reading operation is read by the reading portion after the first reading operation and the second exchange preparation operation and before execution of the image forming operation. That is, the engine controller 1403 is configured to read the cartridge information 1500 and the image forming condition 1501 before the image forming operation.

When the condition acquisition controller 1423 acquires the image forming condition of the toner cartridge 7y for yellow, the toner cartridge controller 1412 causes the condition acquisition request storage portion 1425 to change the Y acquisition request to no request (1621d). Further, the toner cartridge controller 1412 provides an instruction to the rotary controller 1431 to rotate the position of the rotary 9 to the home position (1621f). The state of the rotary 9 is during rotation, in the rotational direction Ra (or the rotational direction Rb) from the Y memory access position toward the home position, in a period from 1621f to 1622f described later. When the position of the rotary 9 is changed from the memory access position to the home position, the toner cartridge controller 1412 completes the toner cartridge exchange (1622f).

In FIG. 16, processing during the execution of the two toner cartridges 7y and 7c was described, but the same applies to reading processing during exchange the three or more toner cartridges. That is, after a part of information is read from the storing portion of one toner cartridge, exchange control of a subsequent toner cartridge is executed. This operation is repeated until exchange control of a final toner cartridge is executed. Then, after the final toner cartridge is exchanged, remaining information is read from the storing portion of each of the toner cartridges. Incidentally, as in the case of the toner cartridge 7c in FIG. 16, as regards the finally exchanged toner cartridge, all the pieces of information may be read. In that case, after all the pieces of information of the finally exchanged toner cartridge is read, remaining information is read from the storing portion of each of the toner cartridges other than the finally exchanged toner cartridge.

Further, the control described above can also be said as follows. In the case where the toner cartridge controller 1412 receives the exchange request of the first toner cartridge and the second toner cartridge, the toner cartridge controller 1412 performs the first exchange preparation operation. The toner cartridge controller 1412 performs a first reading preparation operation after the first exchange preparation operation, and performs the second exchange preparation operation after the first reading preparation operation. Further, the toner cartridge controller 1412 can also be said that a second reading preparation operation and the first reading preparation operation are performed after the second exchange preparation operation and before the image forming operation. Here, according to FIG. 16, an operation from 1612f to 1613f is an example of the first reading preparation operation in which the rotary is positioned in the first reading position by the driving source. An operation from 1616f to 1617f is an example of the second reading preparation operation in which the rotary is positioned in the second reading position by the driving source.

### Description of flowchart of embodiment 1

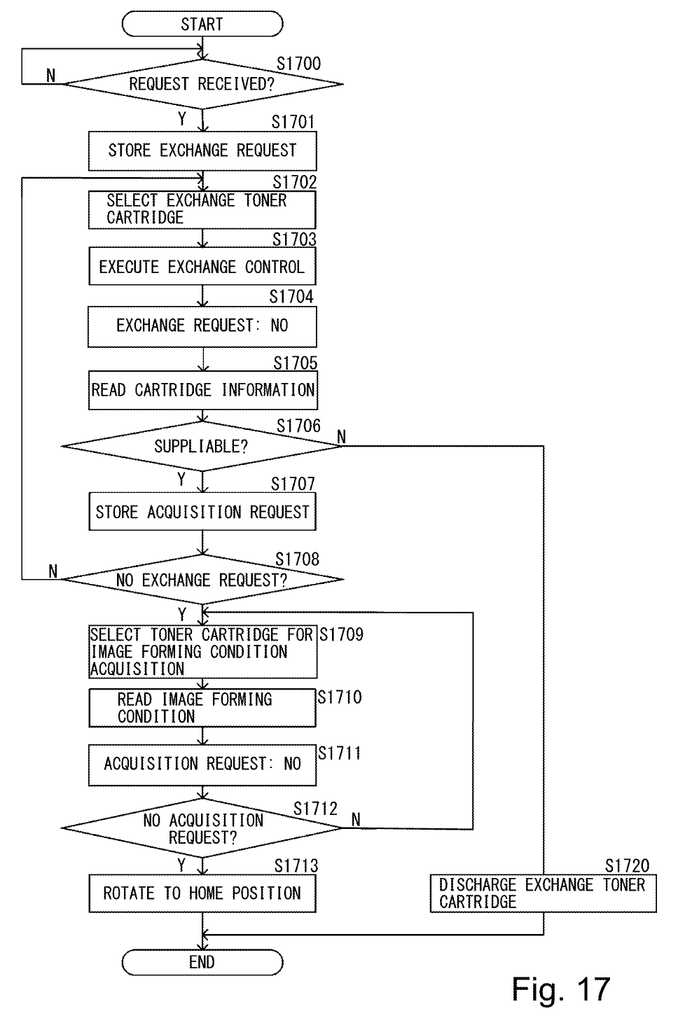

FIG. 17 is a flowchart during the toner cartridge exchange in the embodiment 1. The flowchart in FIG. 17 is a flowchart for exchanging the toner cartridge 7 exchange-requested by the user.

In a step (hereinafter, referred to as "S") 1700, the toner cartridge controller 1412 discriminates whether or not the exchange request of the toner cartridge 7 is received. In the case where the toner cartridge controller 1412 discriminated in S1700 that the exchange request of the toner cartridge 7 is not received, the processing is returned to S1700, and in the case where the toner cartridge controller 1412 discriminated that the exchange request of the toner cartridge 7 is received, the processing is caused to go to S1701. In S1701, the toner cartridge controller 1412 causes the exchange color request storage portion 1421 to store the exchange request of the exchange-requested toner cartridge 7. At this time, the toner cartridge controller 1412 causes the exchange color request storage portion 1421 to store all the exchange requests of the toner cartridge 7 requested through the video interface portion 1410.

In S1702, the toner cartridge controller 1412 selects the toner cartridge 7 to be exchanged. In the embodiment 1, the exchange request of the toner cartridge 7 is checked in the order of the toner cartridge 7y for yellow, the toner cartridge 7m for magenta, the toner cartridge 7c for cyan, and the toner cartridge 7k for black. As in the timing chart of FIG. 16, in the case where there is an exchange request of the toner cartridge 7c together with the exchange request of the toner cartridge 7y for yellow, the toner cartridge 7y for yellow is exchanged early, and then the toner cartridge 7c for cyan is exchanged.

In S1703, the toner cartridge controller 1412 causes the exchange controller 1420 to execute the exchange control of the selected toner cartridge 7. In order to execute the exchange control of the toner cartridge 7, the exchange controller 1420 causes the driving portion to rotate the position of the rotary 9 to the exchange position of the toner cartridge 7 and to slide the tray 8 to a position where the user is capable of exchanging the toner cartridge 7. When the user exchanges the toner cartridge 7, the exchange controller 1420 causes the driving portion to slide the tray 8 to the inside of the rotary 9.

When the toner cartridge 7 is exchanged, in S1704, the toner cartridge controller 1412 causes the exchange color request storage portion 1421 to change the exchange request of the exchanged toner cartridge 7 to no request. In S1705, the toner cartridge controller 1412 causes the information acquisition controller 1422 to read cartridge information of the exchanged toner cartridge 7. After the position of the rotary 9 is rotated to the memory access position, the information acquisition controller 1422 causes the memory communication controller 1430 to access the memory 60 of the toner cartridge 7 and to read the cartridge information 1500 in accordance with a memory map.

In S1706, when acquisition of the cartridge information 1500 of the exchanged toner cartridge 7 is completed, the toner cartridge controller 1412 causes the supply discriminating portion 1424 to discriminate (checks) whether or not the toner can be supplied to the developing unit 5. As an example, the supply discriminating portion 1424 discriminates whether or not depending on whether or not the color the exchanged toner cartridge 7 is the same as the color of the developing unit 5 as the supply object. In S1706, in the case where the supply discriminating portion 1424 discriminated that the toner can be supplied, the toner cartridge controller 1412 causes the processing to go to S1707. By this, after the first reading operation, supply of the toner from the first toner cartridge 7 to the first developing device is started. As described above, when the rotary 9 is rotated by exceeding the angle α, the toner is supplied from the toner cartridge 7 to the developing unit 5.

In S1707, the toner cartridge controller 1412 causes the condition acquisition request storage portion 1425 to store an image forming condition acquisition request (hereinafter, referred to as an acquisition request) of the exchanged toner cartridge 7. In S1708, the toner cartridge controller 1412 discriminates whether or not there is no subsequent exchange request in the exchange color request storage portion 1421. In S1708, in the case where the toner cartridge controller 1412 discriminated that there is a subsequent exchange request, the toner cartridge controller 1412 causes the reading to return to S1702. The toner cartridge controller 1412 repeats the toner cartridge exchange control, the reading of the cartridge information 1500, and the supply discrimination until the exchange request in the exchange color request storage portion 1421 disappears.

In S1708, in the case where the toner cartridge controller 1412 discriminated that there is no subsequent exchange request, the toner cartridge controller 1412 causes the processing to go to S1709. When all the toner cartridges 7 requested by the user are exchanged, in S1709, the toner cartridge controller 1412 selects the toner cartridge 7 for acquiring the image forming condition 1501.

A toner cartridge selecting method in S1709 is as follows. First, the toner cartridge controller 1412 selects the toner cartridge 7 from which the cartridge information 1500 is finally read. This is because the position of the rotary 9 becomes the memory access position of the toner cartridge 7 from which the cartridge information 1500 is finally read (see, 1617f in FIG. 16). By this, the image forming condition 1501 can be acquired without rotating the position of the rotary 9. Next, the toner cartridge controller 1412 checks the acquisition request in the condition acquisition storage portion 1425 in the order of the toner cartridge 7y for yellow, the toner cartridge 7m for magenta, the toner cartridge 7c for cyan, and the toner cartridge 7k for black.

When the toner cartridge 7 for acquiring the image forming condition 1501 is selected, in S1710, the toner cartridge controller 1412 provides an instruction to the condition acquisition controller 1423 to acquire the image forming condition 1501 of the selected toner cartridge 7. In the case where the position of the rotary 9 is not the memory access position of the toner cartridge 7, the condition acquisition controller 1423 causes the driving portion to rotate the position of the rotary 9 to the memory access position of the toner cartridge 7. Thereafter, the condition acquisition controller 1423 causes the memory communication controller 1430 to access the memory 60 of the toner cartridge 7 and to read the image forming condition 1501 in accordance with the memory map of FIG. 12.

When the condition acquisition controller 1423 acquires the image forming condition 1501, in S1711, the toner cartridge controller 1412 changes the acquisition request of the selected toner cartridge 7 to no request. In S1712, the toner cartridge controller 1412 discriminates whether or not there is no acquisition request in the condition acquisition request storage portion 1425. In the case where the toner cartridge controller 1412 discriminates in S1712 that there is an acquisition request in the condition acquisition request storage portion 1425, the toner cartridge controller 1412 causes the processing to return to S1709 and repetitively carries out the processing of S1709 and later until the acquisition request disappears. In the case where the toner cartridge controller 1412 discriminated in S1712 that there is no acquisition request, the toner cartridge controller 1412 causes the processing to go to S1713. The acquisition of the image forming conditions 1501 of all the exchanged toner cartridges 7 is completed, and therefore, in S1713, the toner cartridge controller 1412 ends the processing by rotating the position of the rotary 9 to the home position. Then, the engine controller 1403 takes a state (print ready state) in which execution of the image forming operation is possible.

In the case where the supply discriminating portion 1424 discriminated in S1706 that the toner cannot be supplied to the developing unit 5 as the supply object, the toner cartridge controller 1412 causes the processing to go to S1720. In S1720, the exchange controller 1420 causes the driving portion to rotate the rotary 9 in the rotational direction Rb to return the position of the rotary 9 to the exchange position from the memory access position, and discharges the exchanged toner cartridge to the outside of the image forming apparatus, and then the toner cartridge controller 1412 ends the processing.

As described above, in the case where the user desires the exchange the plurality of toner cartridges, the image forming apparatus acquires a part of information from the cartridge memory of the exchanged toner cartridge in order to give priority to the toner cartridge exchange by the user. Compared with the case where exchange control of a subsequent toner cartridge is carried out after all the pieces of information are acquired from the cartridge memory of the exchanged toner cartridge, a waiting time of the toner cartridge exchange operation by the user can be reduced. In this embodiment, the color information is an example of the part of information. On the basis of the acquired information, the image forming apparatus discriminates whether or not the toner in the exchanged toner cartridge can be supplied to the developing unit. When the image forming apparatus discriminated that the toner in the exchanged toner cartridge can be supplied to the developing unit, the image forming apparatus carries out exchange control of the subsequent toner cartridge. When exchange of all the toner cartridges is completed, reading of the image forming condition is successively performed in the order from the cartridge memory of the exchanged toner cartridge. By this, the waiting time of the toner cartridge exchange operation by the user can be reduced while preventing erroneous mounting of the toner cartridge to the developing device.

Incidentally, in the embodiment 1, although the configuration in which the toner cartridge exchange is instructed from the operating portion 1401 was described, a configuration in which the toner cartridge exchange is instructed from the host computer 1402 or a configuration in which the toner cartridge exchange is toner cartridge exchange is instructed from a portable terminal such as a smartphone via wireless communication may also be employed.

Incidentally, in this embodiment, on the basis of the color information 1510, the supply discriminating portion 1424 discriminated whether or not the toner supply is executed, but the present disclosure is not limited to this. For example, the toner cartridge 7 has an intrinsic number, and the supply discriminating portion 1424 checks the number, so that a proper combination between the image forming apparatus and the toner cartridge 7 may be confirmed. That is, information read as first information may contain information related to certification of the toner cartridge 7. In the case where a kind of the toner cartridge 7 is different from a predetermined kind, in other words, a combination between the image forming apparatus and the toner cartridge 7 is different from a predetermined combination, information related to determination as to whether or not the second exchange preparation operation is executed may be displayed on the operating portion 1401. Then, in the case where execution of the second exchange preparation operation is selected by the user, the execution of the second exchange preparation operation may be permitted. Incidentally, the operating portion 1401 is an example of a display portion where information related to the determination as to whether or not the second exchange preparation operation is executed is displayed. As another example of the display portion may be peripheral device connected to the printer main body 1, for example, a person computer, a mobile terminal, or the like.

Incidentally, in the embodiment 1, information of the image forming condition 1501 is not needed in supply control by the supply discriminating portion 1424, but information in the image forming condition 1501 may also be used in supply control by the supply discriminating portion 1424.

Incidentally, in the embodiment 1, a configuration in which the image forming condition 1501 is read after all the toner cartridges 7 for which exchange is requested are exchanged was permitted, but information read after all the toner cartridges 7 are exchanged is not limited thereto.

In the embodiment 1, a configuration in which in the case where the user requests exchange of the plurality of toner cartridges 7, exchange is made in the order of the toner cartridge 7y for yellow, the toner cartridge 7m for magenta, the toner cartridge 7c for cyan, and the toner cartridge 7k for black was described. However, the present disclosure is not limited thereto. The toner cartridges 7 may also be exchanged in an order such that a time for rotating the rotary 9 to the exchange position of the toner cartridge 7 requested to be replaced is minimized.

In the embodiment 1, the reading of the image forming condition 1501 was carried out for the toner cartridge 7 of which cartridge information 1500 is finally read. Thereafter, a configuration in which the reading of the image forming condition 1501 is carried out in the order of the toner cartridge 7y for yellow, the toner cartridge 7m for magenta, the toner cartridge 7c for cyan, and the toner cartridge 7k for black was described, but the present disclosure is not limited thereto. The reading of the image forming condition 1501 may also be carried out in an order such that a time for rotating the rotary 9 to the memory access position of the toner cartridge 7 to read the image forming condition 1501 is minimized.

As described above, according to the embodiment 1, in the case where the plurality of toner cartridges are exchanged, a time until after one toner cartridge is exchanged, exchange of another toner cartridge is permitted can be shortened.

### Embodiment 2

In the embodiment 1, the case where the user requests exchange of one or more toner cartridges at the same timing was described. In an embodiment 2, the case where the user newly requests toner cartridge exchange when the printer main body 1 reads the image forming condition 1501 of the exchanged toner cartridge 7. The printer main body 1 interrupts reading of the image forming condition 1501 in order to give priority to the toner cartridge exchange newly requested by the user.

The printer main body 1 resumes the interrupted reading of the image forming condition 1501 after the newly requested exchange of the toner cartridge 7 is made. As regards a configuration of the embodiment 1, only a portion different from the configuration described in the embodiment 1 will be described. The embodiment 2 is an example in which when an exchange request of a third toner cartridge is received during execution of a third reading operation (reading operation of the image forming condition), the third reading operation is interrupted and then a third exchange preparation operation in which the rotary 9 is positioned in a third exchange position by the driving portion. Here, the third exchange position is a position of the newly exchange-rotated toner cartridge 7, and is a position where the rotary 9 is rotated and mounting of the toner cartridge 7 to the developing unit 5 through the opening 16a is permitted.

### Block diagram of embodiment 2

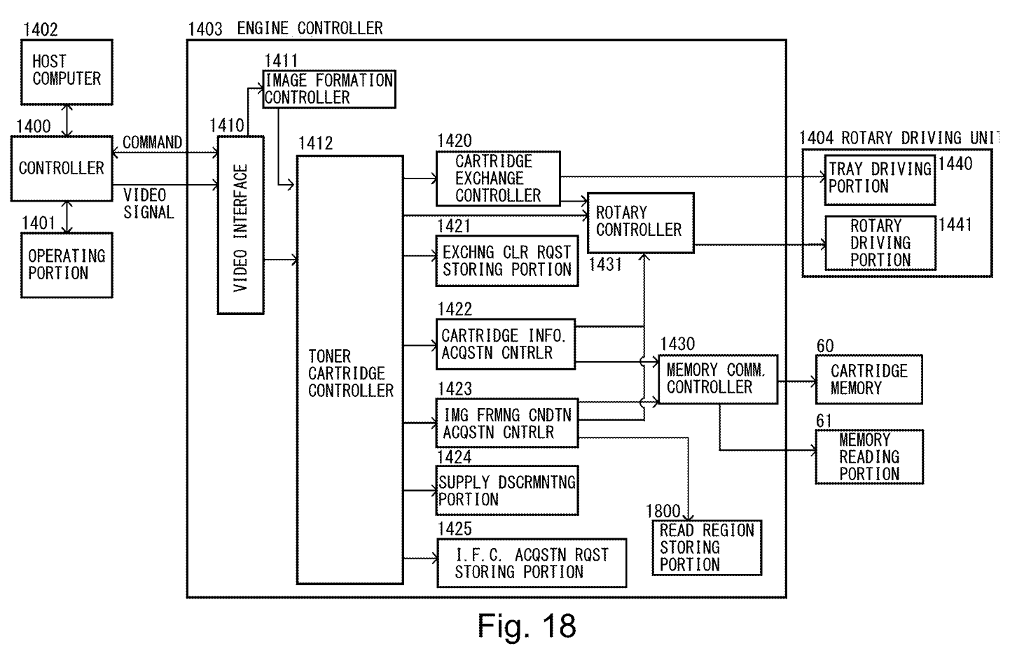

FIG. 18 is a block diagram of the embodiment 2. Only a difference from FIG. 14 will be described. The toner cartridge controller 1412 carries out the following control when the toner cartridge controller 1412 receives a toner cartridge exchange instruction through the video interface portion 1410 when the condition acquisition controller 1423 reads the image forming condition 1501. The toner cartridge controller 1412 causes the exchange color request storage portion 1421 to store the exchange request of the exchange-requested toner cartridge and provides an instruction to the condition acquisition controller 1423 to interrupt the reading of the image forming condition 1501. In the embodiment 2, a read region storage portion 1800 (hereinafter, referred to as a region storage portion 1800) so that the condition acquisition controller 1423 is capable of resuming the reading of the image forming condition 1501 from a region in which the reading is interrupted is provided. The region storage portion 1800 is storage means for storing a reading, in which the reading of the image forming condition 1501 is resumed, when the condition acquisition controller 1423 interrupts the reading of the image forming condition 1501 in the memory 60. For example, in the case where the condition acquisition controller 1423 completes reading to the charging setting 1520 of FIG. 12, information such that reading to the charging setting 1520 is completed (or information such that reading is resumed from the developing setting 1521) is stored in the region storage portion 1800. The region storage portion 1800 includes a region corresponding to each of the toner colors. The printer main body 1 in the embodiment 2 has a four-color configuration of the toner cartridges 7y, 7m, 7c, and 7k. For that reason, the region storage portion 1800 has a region for the four colors.

### Description of timing chart in embodiment 2

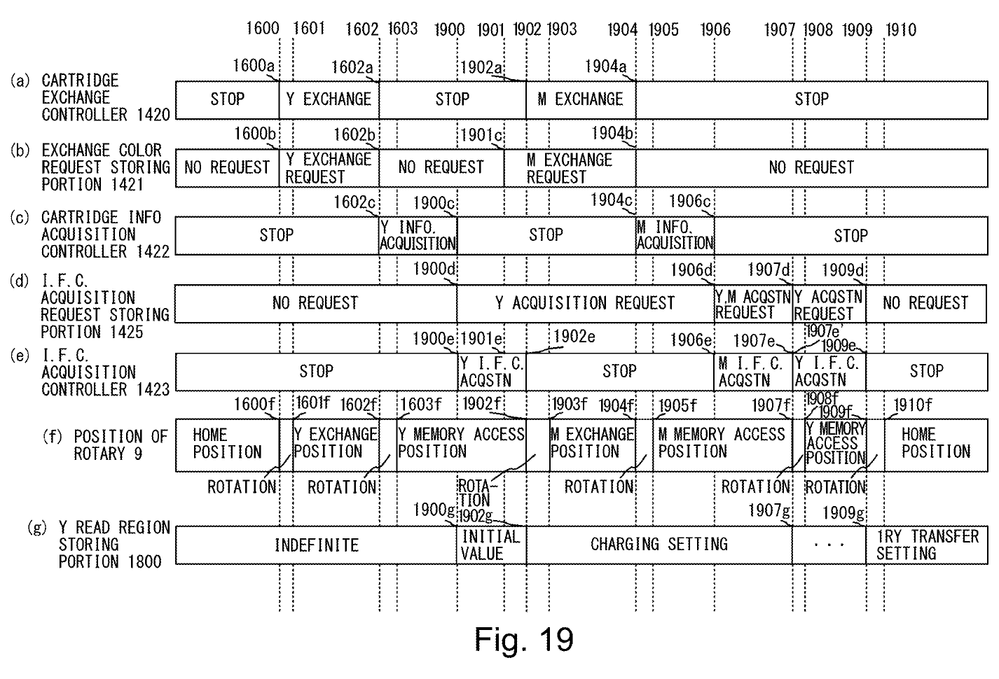

FIG. 19 is a timing chart in the case where the user requests further cartridge exchange during reading of the image forming condition 1501 from the memory 60 by the printer main body 1. An example in which the user requests exchange of the toner cartridge 7y, for yellow and thereafter requests exchange of the toner cartridge 7m for magenta is shown.

Only a difference from the timing chart of FIG. 15 will be described. In FIG. 19, (a) to (f) are similar to (a) to (f) of FIG. 15. In FIG. 19, 1600 to 1603 and 1900 to 1920 show respective timings. Incidentally, 1900c and 1604c,1900d and 1604c, and 1900e and 1604e are merely different in number (symbol), and therefore, description will be omitted. In FIG. 19, (g) shows information stored in a region assigned to the toner cartridge 7y for yellow in the region storage portion 1800.

As described with reference to FIG. 15, after the user exchanges the toner cartridge 7 (1602a), the toner cartridge controller 1412 causes the information acquisition controller 1422 to acquire the cartridge information 1500 (1900c). On the basis of the color information 1510 of the acquired cartridge information 1500, the toner cartridge controller 1412 carries out the following control when the supply discriminating portion 1424 discriminated that the toner can be supplied. That is, the toner cartridge controller 1412 provides an instruction to the condition acquisition controller 1423 to initialize the region storage portion 1800 for the toner cartridge 7y for yellow (1900g). The condition acquisition controller 1423 changes a value stored in the region storage portion 1800 for the toner cartridge 7y to an initial value indicating that the image forming condition 1501 is not acquired. Incidentally, the region storage portion 1800 is in an indefinite state before the initial value is stored. Thereafter, the toner cartridge controller 1412 provides an instruction to the condition acquisition controller 1423 to acquire the image forming condition 1501 for the toner cartridge 7y for yellow (1900e).

The toner cartridge controller 1412 receives a toner cartridge exchange instruction for magenta through the video interface portion 1410 during acquisition of the image forming condition 1501 for the toner cartridge 7y. The toner cartridge controller 1412 causes the exchange color request storage portion 1421 (1901c), and provides an instruction to the condition acquisition controller 1423 to interrupt the reading of the image forming condition 1501 from the toner cartridge 7 for yellow (1901e). The condition acquisition controller 1423 receiving the reading interruption instruction causes the region storage portion 1800 for the toner cartridge 7y to store a finally read region information when acquisition of the region read from the memory 60y for the toner cartridge 7y for yellow is completed. The condition acquisition controller 1423 interrupts the reading of the image forming condition 1501 from the toner cartridge 7y for yellow (1902e). When the condition acquisition controller 1423 interrupts the reading of the image forming condition 1501 from the toner cartridge 7y for yellow, the condition acquisition controller 1423 shifts in state from the state during Y image condition acquisition to the state during stop.

In the example of FIG. 19, the final read region was the charging setting 1520 of the image forming condition 1501, and therefore, the condition acquisition controller 1423 causes the region storage portion 1800 to store that the region to the charging setting is read (1902g). When the condition acquisition controller 1423 interrupts the reading of the image forming condition 1501, the toner cartridge controller 1412 provides an instruction to the exchange controller 1420 to exchange the toner cartridge 7m for magenta (1902a). When the exchange of the toner cartridge 7m for magenta is instructed, the exchange controller 1420 shifts in state from the state during stop to the M exchange state, and provides an instruction to the rotary controller 1431 to rotate the position of the rotary 9 to the M exchange position (1902f). The rotary 9 is during rotation in a period from 1902f to 1903f described later.

When the position of the rotary 9 becomes the M exchange position (1903f), the exchange controller 1420 causes the driving portion to slide the tray 8m to a position where the user is capable of exchanging the toner cartridge 7m for magenta. When the user exchanges the toner cartridge 7m for magenta, the exchange controller 1420 causes the driving portion to slide the tray 8m to the inside of the rotary 9, so that the state of the rotary 9 is shifted from the M exchange state to the state during stop (1904a). When the toner cartridge 7m for magenta is exchanged, the toner cartridge controller 1412 changes the M exchange request stored in the exchange color request storage portion 1421 to no request (1904b). The toner cartridge controller 1412 provides an instruction to the information acquisition controller 1422 to acquire cartridge information 1500 of the exchanged toner cartridge 7m for magenta (1904c). When acquisition of the cartridge information 1500 of the toner cartridge 7m for magenta is instructed from the toner cartridge controller 1412, the information acquisition controller 1422 carries out control in the following manner. That is, the information acquisition controller 1422 shifts in state from the state during stop to a state during M information acquisition and provides an instruction to the rotary controller 1431 to rotate the position of the rotary 9 to the M memory access position (1904f). The state of the rotary 9 is during rotation in a period from 1904f to 1905f described later.

When the position of the rotary becomes the M memory access position (1905f), the information acquisition controller 1422 acquires the memory 60m. When the information acquisition controller 1422 acquires the cartridge information 1500 (1906c), the state of the information acquisition controller 1422 is shifted from the state of during M information acquisition to the state during stop. When the information acquisition controller 1422 acquires the cartridge information 1500, the toner cartridge controller 1412 causes the supply discriminating portion 1424 to discriminate whether or not the toner in the exchanged toner cartridge 7m for magenta may be supplied to the developing unit 5m. When the supply discriminating portion 1424 discriminates from the color information 1510 that the toner in the toner cartridge 7m for magenta can be supplied to the developing unit 5m, the toner cartridge controller 1412 causes the condition acquisition request storage portion 1425 to store the M acquisition request (1906d). At this timing, in the condition acquisition storage portion 1425, the Y acquisition request is kept stored.

The toner cartridge controller 1412 provides an instruction to the condition acquisition controller 1423 to acquire the image forming condition 1501 of the toner cartridge 7m for magenta (1906e). When the acquisition of the image forming condition 1501 of the toner cartridge 7m for magenta is instructed from the toner cartridge controller 1412, the condition acquisition controller 1423 shifts in state from the state during stop to the state during the M image condition acquisition and causes the memory communication controller 1430 to access the memory 60m. When the condition acquisition controller 1423 acquires the image forming condition 1501 (1907e), the condition acquisition controller 1423 shifts in state from the state during the M image condition acquisition to the state during stop. Incidentally, at this timing, the state during the Y image condition acquisition is still maintained.

When the condition acquisition controller 1423 acquires the image forming condition 1501 for the toner cartridge 7m for magenta, the toner cartridge controller 1412 changes the M acquisition request in the condition acquisition request storage portion 1425 to no request, so that the remaining acquisition request is made only the Y acquisition request (1907d). The toner cartridge controller 1412 provides an instruction to the condition acquisition controller 1423 to acquire the reading-interrupted image forming condition 1501 for the toner cartridge 7y for yellow (1907e'). When resumption of the acquisition of image forming condition 1501 for the toner cartridge 7y for yellow is instructed from the toner cartridge controller 1412, the condition acquisition controller 1423 shifts in state from the state during stop to the state during the Y image condition acquisition. The condition acquisition controller 1423 provides an instruction to the rotary controller 1431 to rotate the position of the rotary 9 to the Y memory access position (1907f). The rotary 9 becomes during rotation in a period from 1907f to 1908f described later.

When the position of the rotary 9 becomes the Y memory access position (1908f), the condition acquisition controller 1423 causes the memory communication controller 1430 to access the memory 60. The condition acquisition controller 1423 resumes acquisition of the image forming condition 1501 from the developing setting 1521 which is a region subsequent to the charging setting 1520 stored in the region storage portion 1800 for the toner cartridge 7y for yellow (1907g). The condition acquisition controller 1423 reads all the remaining parts (to the primary transfer setting 1522 in FIG. 12) of the image forming condition 1501 for the toner cartridge 7y. The condition acquisition controller 1423 causes the region storage portion 1800 to store that all the parts (for example, to the primary transfer setting 1522) of the image forming condition 1501 are read, in the region storage portion 1800 for the toner cartridge 7y (1909g). The condition acquisition controller 1423 completes the reading of the image forming condition 1501.

When the condition acquisition controller 1423 acquires the image forming condition 1501 (1909e), the condition acquisition controller 1423 shifts in state from the state during the Y image condition acquisition to the state during stop. When the condition acquisition controller 1423 reads the image forming condition 1501 for the toner cartridge 7y for yellow, the toner cartridge controller 1412 changes the Y acquisition request in the condition acquisition request storage portion 1425 to no request (1909d).

Finally, the toner cartridge controller 1412 provides an instruction to the rotary controller 1431 to rotate the position of the rotary 9 to the home position (1909f). The rotary 9 becomes during rotation in a period from 1909f to 1910f described later. When the position of the rotary 9 is changed from the Y memory access position to the home position, the toner cartridge controller 1412 completes the toner cartridge exchange (1910f).

### Description of flowchart in embodiment 2

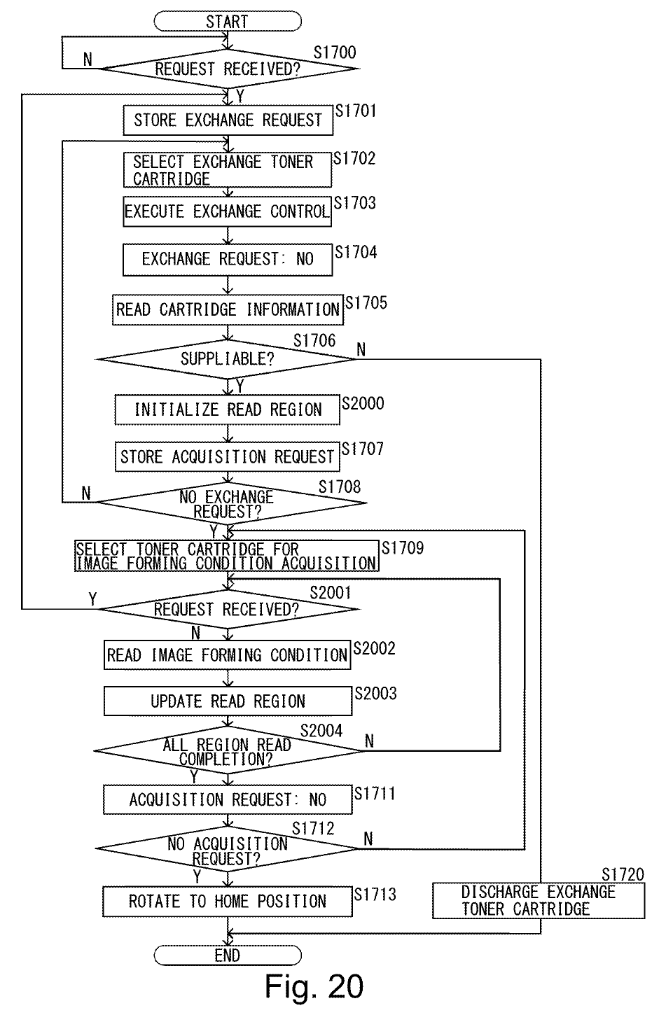

FIG. 20 is a flowchart during the toner cartridge exchange in the embodiment 2. In the flowchart of FIG. 20, the processing which is the same as the processing of FIG. 17, the same step numbers are added, and description thereof is omitted, and only a difference from FIG. 17 will be descried. In the flowchart of FIG. 20, the case where the user newly requests the toner cartridge exchange during acquisition of the image forming condition 1501 for the toner cartridge exchanged by the user.

When the toner cartridge controller 1412 discriminates that the toner in the exchanged toner cartridge 7 can be supplied by a discrimination result of the supply discriminating portion 1424 (S1706: Y), the toner cartridge controller 1412 causes the processing to go to S2000. In S2000, the toner cartridge controller 1412 provides an instruction to the condition acquisition controller 1423 to initialize a region of the region storage portion 1800 corresponding to the color of the exchanged toner cartridge 7. The condition acquisition controller 1423 initializes the region of the region storage portion 1800 for a designated color.

The toner cartridge controller 1412 selects the toner cartridge 7 for which the image forming condition 1501 is acquired (S1709), and then discriminates in S2001 whether or not the toner cartridge exchange request is received. In the case where the toner cartridge controller 1412 discriminated in S2001 that the toner cartridge exchange request is received, the toner cartridge controller 1412 causes the processing to return to S1701. The toner cartridge controller 1412 causes the exchange color request storage portion 1421 to store the exchange request of the exchange-requested toner cartridge (S1701), and selects the toner cartridge to be exchanged (S1702). The toner cartridge controller 1412 provides an instruction to the exchange controller 1420 to exchange the selected toner cartridge 7 (S1703), so that the user is capable of exchanging the toner cartridge 7.

In the case where the toner cartridge controller 1412 discriminated in S2001 that the toner cartridge exchange request is not received, the toner cartridge controller 1412 causes the processing to go to S2002. In S2002, the toner cartridge controller 1412 provides an instruction to the condition acquisition controller 1423 to acquire the image forming condition 1501 for the selected toner cartridge 7. The condition acquisition controller 1423 reads the image forming condition 1501 from a region subsequent to the region stored in the region storage portion 1800. In the case where the value in the region storage portion 1800 is an initial value, the condition acquisition controller 1423 reads the image forming condition 1501 from the beginning. In S2003, the toner cartridge controller 1412 updates the region storage portion 1800. When the condition acquisition controller 1423 reads a part of the image forming condition 1501, the condition acquisition controller 1423 updates the region storage portion 1800.

In S2004, in the case where the toner cartridge controller 1412 discriminates whether or not there is an image forming condition 1501 which is not read by the condition acquisition controller 1423. In the case where the toner cartridge controller 1412 discriminated in S2004 that all the image forming conditions 1501 are not read, the toner cartridge controller 1412 causes the processing to return to S2001, and reading of the image forming condition 1501 is continued. In the case where the exchange request of the toner cartridge 7 newly occurs during a loop from S2001 to S2004, the reading of the image forming condition 1501 is interrupted, and the toner cartridge controller 1412 makes the discrimination “Y” in S2001, so that the processing is returned to S1701.

In S2004, in the case where the toner cartridge controller 1412 discriminated that reading of all the image forming conditions 1501 is completed, the toner cartridge controller 1412 causes the processing to go to S1711. The toner cartridge controller 1412 changes the acquisition request for the selected toner cartridge 7 to no request in the condition acquisition request storage portion 1425 (S1711), and then checks whether or not there is no acquisition request in the condition acquisition request storage portion 1425 (S1712). Subsequent steps are as described above with reference to FIG. 17.

As described above, the toner cartridge controller 1412 carries out control in the following manner when the exchange of the toner cartridge newly requested from the user during the third reading operation. That is, the toner cartridge controller 1412 interrupts the third reading operation and performs the exchanging operation and the first reading operation. The toner cartridge controller 1412 resumes the third reading operation after the exchanging operation and the first reading operation for each of all the toner cartridges including the toner cartridge before which the exchange is newly requested is ended.

That is, in the case where the user newly requests the exchange of the toner cartridge 7 during reading of the image forming condition 1501 for the exchanged toner cartridge 7, the printer main body 1 carries out control so as to give priority to the toner cartridge exchange by the user. The printer main body 1 interrupts the reading of the image forming condition 1501 in order to give priority to the exchange of the toner cartridge 7. Thereafter, the printer main body 1 carries out the cartridge exchange control. When the cartridge exchange is completed, the printer main body 1 performs the reading of the image forming condition 1501 in the memory 60 of the toner cartridge 7. As regards the toner cartridge 7 for which reading of the image forming condition 1501 is interrupted, by storing the read region in the storage portion, the printer main body 1 is not required to perform unnecessary reading (redundancy of reading) of the image forming condition. By this, even in the case where the user additionally exchanges the toner cartridge 7 after exchanging the toner cartridge 7, a waiting time of the user in the cartridge exchanging operation can be reduced while preventing mounting of the toner cartridge 7 to an erroneous developing device.

Incidentally, in the embodiment 2, a configuration in which when the user newly requests the toner cartridge exchange when the condition acquisition controller 1423 reads the image forming condition 1501, the reading is always interrupted was described, but the present disclosure is not limited thereto. A condition as to whether or not the condition acquisition controller 1423 interrupts the reading of the image forming condition 1501 is provided, and only in the case where the condition is satisfied, the reading of the image forming condition 1501 may be interrupted.

As described above, according to the embodiment 2, in the case where the plurality of toner cartridges are exchanged, a time from after one toner cartridge is exchanged until exchange of another toner cartridge is permitted can be reduced.

### Modified embodiments

In the above-described embodiments, the operation in the case where the first toner cartridge is mounted to the rotary main body 90 in a state in which mounting of the first toner cartridge and the second toner cartridge is permitted is described. In other words, an operation in the case where the first toner cartridge is mounted in a state in which the mounting of the second toner cartridge is permitted.

In either of the above-described embodiments, the exchange preparation operation of the second toner cartridge is performed after the first information is read from the storing portion of the first toner cartridge and before the second information is read.

In each of the above-described embodiments, the cartridge information 1500 is an example of the first information and the information related to the image forming condition 1501 is an example of the second information, but the first information and the second information are not limited thereto. For example, the first information may include information related to certification of the toner cartridge.

Further, when a processing operation based on the first information is a first processing operation and a processing operation based on the second information is a second processing operation, the engine controller 1403 is configured to perform the first processing operation and the second processing operation before the image forming operation is executed. The engine controller 1403 is configured to perform the first processing operation before the exchange preparation operation of the second toner cartridge is executed and to perform the second processing operation before the exchange preparation operation of the second toner cartridge and the image forming operation are executed. The first processing operation may be shorter than the second processing operation.

The second processing operation may contain one or more transmitting operations for transmitting information from the engine controller 1403 to the storing portion of the first toner cartridge. Further, the second processing operation may contain a reading operation of information stored in the storing portion of the first toner cartridge and may contain a plurality of transmitting operations (writing operations) for transmitting information from the engine controller 1403 to the storing portion of the first toner cartridge. For example, the second processing operation may contain transmission (writing) of certification data from the engine controller 1403 to the storing portion of the first toner cartridge and may contain reading of return data from the storing portion of the first toner cartridge. That is, as the second processing operation, the engine controller 1403 may perform a certification operation containing an operation such that data is transmitted to the storing portion of the first toner cartridge and response from the storing portion of the first toner cartridge is received. In this case, a time of the second processing operation becomes relatively long, and therefore, the exchange of the second toner cartridge is permitted before the second processing operation is performed, whereby a waiting time of the user can be shortened.

Incidentally, the first processing operation and the second processing operation may beam operation of the same kind. For example, the first processing operation may contain a certification operation performed between a first certification portion and the storing portion of the first toner cartridge, and the second processing operation may contain a certification operation performed between a second certification portion and the storing portion of the first toner cartridge. In this case, either one of the certification contacts may contain an operation such that data is transmitted from an associated certification portion to the storing portion of the first toner cartridge and response from the storing portion of the first toner cartridge is received.

According to the present disclosure, in the case where a plurality of toner cartridges are exchanged, a time from after one toner cartridge is exchanged until exchange of another toner cartridge is permitted can be shortened.

### Other Embodiments

The above-described embodiments of the present disclosure can also be realized by a computer of a system or apparatus that reads out and executes computer executable instructions (e.g., one or more programs) recorded on a storage medium (which may also be referred to more fully as a "non-transitory computer-readable storage medium") to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application Nos. 2025-021892, filed on February 13, 2025, and 2025-243781, filed on December 9, 2025, which are hereby incorporated by reference herein in their entirety.

What is claimed is:

1. An image forming apparatus to which a first toner cartridge including a first storing portion and a second toner cartridge are detachably mountable, wherein the image forming apparatus is configured to execute an image forming operation for forming an image on a recording material, the image forming apparatus comprising:
a photosensitive drum;
a rotary to which the first toner cartridge and the second toner cartridge are detachably mountable, the rotary including
(i) a first developing device accommodating toner supplied from the first toner cartridge and including a first developing roller, and
(ii) a second developing device accommodating toner supplied from the second toner cartridge and including a second developing roller,
wherein the rotary is rotatable so that each of the first developing roller and the second developing roller opposes the photosensitive drum;
a main assembly accommodating the rotary and provided with an opening;
a reading portion;
a driving portion configured to rotate the rotary so that the rotary takes a first exchange position and a second exchange position, wherein mounting of the first toner cartridge to the first developing device through the opening is permitted when the rotary is in the first exchange position, and mounting of the second toner cartridge to the second developing device through the opening is permitted when the rotary is in the second exchange position; and
a controller configured to control the driving portion,
wherein in a case where the first toner cartridge is mounted to the rotary, the controller reads first information and second information from the first storing portion through the reading portion before the image forming operation is executed, and
wherein in a case where the first toner cartridge is mounted to the rotary in a state in which mounting of the second toner cartridge to the rotary is permitted, the controller performs
(i) a first reading operation for reading the first information, and
(ii) an exchange preparation operation for positioning the rotary in the second exchange position after the first reading operation and before a first additional reading operation for reading the second information.

2. The image forming apparatus according to claim 1, wherein the second toner cartridge includes a second storing portion, and
wherein after the exchange preparation operation, the controller performs a second reading operation in which at least a part of information stored in the second storing portion of the second toner cartridge mounted to the rotary is read through the reading portion.

3. The image forming apparatus according to claim 2, wherein to the rotary, a third toner cartridge including a third storing portion is detachably mountable, and the rotary includes a third developing device including a third developing roller,
wherein the driving portion rotates the rotary so as to take a third exchange position where mounting of the third toner cartridge to the third developing device through the opening is permitted, and
wherein when the mounting of the third toner cartridge is instructed during execution of the first additional reading operation, the controller interrupts the first additional reading operation and positions the rotary in the third exchange position.

4. The image forming apparatus according to claim 1, wherein the controller reads information related to a kind of the first toner cartridge in the first reading operation, and
wherein the controller performs the exchange preparation operation in a case where the kind coincides with a predetermined kind, and positions the rotary in the first exchange position in a case where the kind is different from the predetermined kind.

5. The image forming apparatus according to claim 1, wherein after the first reading operation, supply of the toner from the first toner cartridge to the first developing device is started.

6. The image forming apparatus according to claim 5, wherein when a position of the rotary where the first reading operation is permitted is a first reading position, a rotational direction in which the rotary is rotated after the first reading operation is opposite to a rotational direction of the rotary when the rotary is moved from the first exchange position to the first reading position.

7. The image forming apparatus according to claim 1, wherein the rotary includes a first tray to which the first toner cartridge is detachably mountable and a second tray to which the second toner cartridge is detachably mountable, and
wherein the controller performs an operation for moving the first tray to an outside of the main assembly through the opening and performs an operation for moving the second tray to the outside of the main assembly through the opening.

8. An image forming apparatus to which a first toner cartridge including a first storing portion and a second toner cartridge including a second storing portion are detachably mountable, wherein the image forming apparatus is configured to execute an image forming operation for forming an image on a recording material, the image forming apparatus comprising:
a photosensitive drum;
a rotary to which the first toner cartridge and the second toner cartridge are detachably mountable, the rotary including
(i) a first developing device accommodating toner supplied from the first toner cartridge and including a first developing roller, and
(ii) a second developing device accommodating toner supplied from the second toner cartridge and including a second developing roller,
wherein the rotary is rotatable so that each of the first developing roller and the second developing roller opposes the photosensitive drum;
a main assembly accommodating the rotary and provided with an opening;
a reading portion;
a driving portion configured to rotate the rotary so that the rotary takes a first exchange position, a second exchange position, a first reading position, and a second reading position, wherein mounting of the first toner cartridge to the first developing device through the opening is permitted when the rotary is in the first exchange position, mounting of the second toner cartridge to the second developing device through the opening is permitted when the rotary is in the second exchange position, reading of information, stored in the first storing portion, by the reading portion is permitted when the rotary is in the first reading position, and reading of information, stored in the second storing portion, by the reading portion is permitted when the rotary is in the second reading position; and
a controller configured to control the driving portion,
wherein in a case where the first toner cartridge is mounted to the rotary in a state in which mounting of the second toner cartridge to the rotary is permitted, the controller performs a first reading preparation operation for positioning the rotary in the first reading position and an exchange preparation operation for positioning the rotary in the second exchange position after the first reading preparation operation, and performs, after the exchange preparation operation and before the image forming operation, a second reading preparation operation for positioning the rotary in the second reading position and the first reading preparation operation.

9. The image forming apparatus according to claim 8, wherein the controller reads information related to a kind of the first toner cartridge before the exchange preparation operation, and
wherein the controller performs the exchange preparation operation in a case where the kind coincides with a predetermined kind, and performs an operation for positioning the rotary in the first exchange position in a case where the kind is different from the predetermined kind.

10. The image forming apparatus according to claim 8, wherein after the exchange preparation operation, supply of the toner from the first toner cartridge to the first developing device is started.

11. The image forming apparatus according to claim 10, wherein a rotational direction of the rotary when the rotary is moved from the first reading position to the second exchange position is opposite to a rotational direction of the rotary when the rotary is moved from the first exchange position to the first reading position.

12. The image forming apparatus according to claim 8, wherein the rotary includes a first tray to which the first toner cartridge is detachably mountable and a second tray to which the second toner cartridge is detachably mountable, and
wherein the controller performs an operation for moving the first tray to an outside of the main assembly through the opening and performs an operation for moving the second tray to the outside of the main assembly through the opening.
